(19) United States
(12) Patent Application Publication
(10) Pub. No.: US 2026/0277298 A1
(43) Pub. Date: Sep. 17, 2026

(54) SENSOR SYSTEM, SENSOR DEVICE, AND AP DEVICE

(71) Applicant: Sony Semiconductor Solutions Corporation, Kanagawa (JP)

(72) Inventor: Noriyuki Natsukawa, Kanagawa (JP)

(21) Appl. No.: 19/473,651

(22) PCT Filed: Apr. 8, 2024
(86) PCT No.: PCT/JP24/14220

§ 371 Date: Oct. 8, 2025

(30) Foreign Application Priority Data
May 24, 2023 (JP) 2023-085549

(51) Int. Cl. G06F 1/3287

(52) U.S. Cl. CPC G06F 1/3287

(57) ABSTRACT

A sensor system includes: a sensor device; and an application processor (AP) device that uses the sensor device, in which the sensor device includes: a first in-sensor power domain (PD) and a second in-sensor PD of which power-on and power-off can be individually controlled; and a TxIF circuit that is provided across the first in-sensor PD and the second in-sensor PD and transmits data, the AP device includes: a first in-AP PD and a second in-AP PD of which power-on and power-off can be individually controlled; and an RxIF circuit that is provided across the first in-AP PD and the second in-AP PD and receives the data, the first in-sensor PD and the first in-AP PD provide a layer higher than a physical layer, and the second in-sensor PD and the second in-AP PD provide the physical layer.

### FIELD

The present disclosure relates to a sensor system, a sensor device, and an AP device.

### BACKGROUND

There is known technology for reducing power consumption by controlling power-on and power-off of a communication circuit in a device. Technology regarding how to maintain communication at the time of a power shutdown has also been studied. For example, Patent Literature 1 discloses technology of providing a connection maintaining circuit that bypasses a serial communication control circuit in a configuration in which a serial communication control circuit chained to each processor core in a system LSI is provided in such a manner that communication can be maintained even when the power supply of some of processor cores is turned off.

### Citation List

### Patent Literature

Patent Literature 1: JP 2004-127169 A

### SUMMARY

### Technical Problem

Separately providing a connection maintaining circuit as in Patent Literature 1 complicates the circuit configuration and reduces the advantage of power consumption reduction. There is also a problem that there is a trade-off relationship between a reduction in power consumption due to a power shutdown and the recovery time from the power shutdown. This point is not particularly studied in Patent Literature 1.

One aspect of the present disclosure improves the trade-off between the reduction in power consumption due to a power shutdown and the recovery time from the power shutdown.

### Solution to Problem

A sensor system according to one aspect of the present disclosure includes: a sensor device; and an application processor (AP) device that uses the sensor device, wherein the sensor device includes: a first in-sensor power domain (PD) and a second in-sensor PD of which power-on and power-off can be individually controlled; and a TxIF circuit that is provided across the first in-sensor PD and the second in-sensor PD and transmits data, the AP device includes: a first in-AP PD and a second in-AP PD of which power-on and power-off can be individually controlled; and an RxIF circuit that is provided across the first in-AP PD and the second in-AP PD and receives the data, the first in-sensor PD and the first in-AP PD provide a layer higher than a physical layer, and the second in-sensor PD and the second in-AP PD provide the physical layer.

A sensor device according to one aspect of the present disclosure includes: a first in-sensor power domain (PD) and a second in-sensor PD of which power-on and power-off can be individually controlled; and a TxIF circuit that is provided across the first in-sensor PD and the second in-sensor PD and transmits data, wherein the first in-sensor PD provides a layer higher than a physical layer, and the second in-sensor PD provides the physical layer.

An application processor (AP) device according to one aspect of the present disclosure uses a sensor device, the AP device includes: a first in-AP power domain (PD) and a second in-AP PD of which power-on and power-off can be individually controlled; and an RxIF circuit that receives data from the sensor device, the RxIF circuit provided across the first in-AP PD and the second in-AP PD, wherein the first in-AP PD provides a layer higher than a physical layer, and the second in-AP PD provides the physical layer.

### BRIEF DESCRIPTION OF DRAWINGS

FIG. 1 is a diagram illustrating an exemplary schematic configuration of a sensor system 1 according to an embodiment.

FIG. 2 is a diagram illustrating an exemplary TxIF circuit 23.

FIG. 3 is a diagram illustrating an example of states (operations) of the TxIF circuit 23 and an RxIF circuit 33.

FIG. 4 is a graph illustrating an example of states (operations) of the TxIF circuit 23 and the RxIF circuit 33.

FIG. 5 is a diagram illustrating an example of transition to a low amplitude state and a default amplitude state.

FIG. 6 is a diagram illustrating an example of transition to the low amplitude state and the default amplitude state.

FIG. 7 is a diagram illustrating an example of intermittent operation of the TxIF circuit 23 and the RxIF circuit 33.

FIG. 8 is a diagram illustrating an example of intermittent operation of the TxIF circuit 23 and the RxIF circuit 33.

FIG. 9 is a table illustrating an example of a register 201.

FIG. 10 is a table illustrating an example of a register 301.

FIG. 11 is a diagram illustrating an example of a schematic configuration of a PMU 204.

FIG. 12 is a diagram illustrating an example of a schematic configuration of a PMU 304.

FIG. 13 is a flowchart illustrating an example of processing (control method) executed in the sensor system 1.

FIG. 14 is a flowchart illustrating an example of processing (control method) executed in the sensor system 1.

FIG. 15 is a flowchart illustrating an example of processing (control method) executed in the sensor system 1.

FIG. 16 is a flowchart illustrating an example of processing (control method) executed in the sensor system 1.

FIG. 17 is a diagram illustrating an exemplary structure of data transferred from a sensor device 2 to an AP device 3.

### DESCRIPTION OF EMBODIMENTS

Hereinafter, embodiments of the present disclosure will be described in detail on the basis of the drawings. Note that in each of the following embodiments, the same elements are denoted by the same symbols, and redundant description will be omitted.

The present disclosure will be described in the following order of items.
1. Embodiments
2. Modifications
3. Summary

### 1. Embodiments

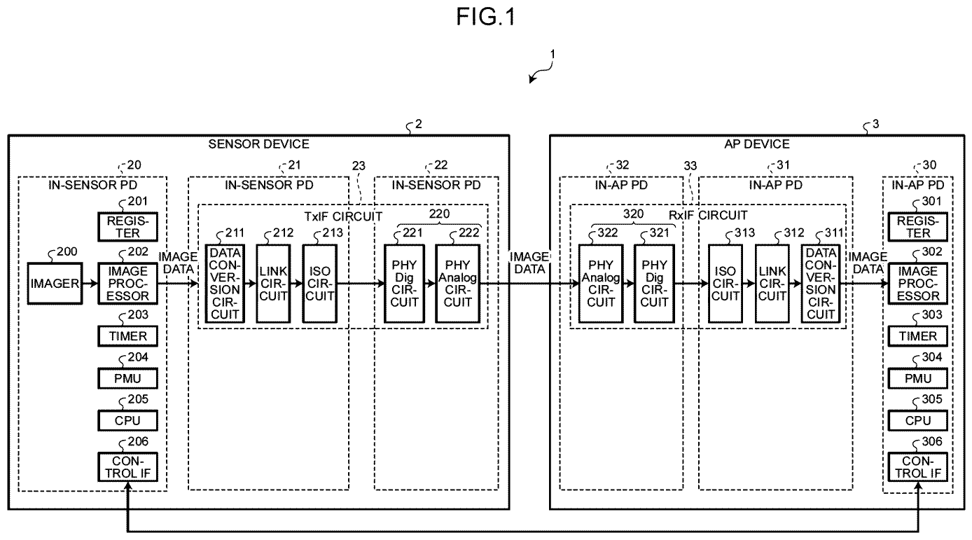

FIG. 1 is a diagram illustrating an exemplary schematic configuration of a sensor system 1 according to an embodiment. The sensor system 1 includes a sensor device 2 and an application processor (AP) device 3. The AP device 3 uses the sensor device 2 and can also be referred to as a host or the like. In the sensor system 1, the sensor device 2 and the AP device 3 communicate with each other. In this sense, the sensor system 1 can also be referred to as a communication system.

Hereinafter, it is based on a premise that the sensor device 2 is an imaging device (such as a solid-state imaging device or an image sensor). The sensor system 1 can also be referred to as an imaging system.

The sensor device 2 includes a plurality of power domains (PDs) of which power-on (power supply) and power-off (no power supply) can be individually controlled. In the example illustrated in FIG. 1, the sensor device 2 includes an in-sensor PD 20, an in-sensor PD 21 (first in-sensor PD), and an in-sensor PD 22 (second in-sensor PD). In a case where they are not particularly distinguished from each other, they are simply referred to as in-sensor PDs.

An in-sensor PD 20 includes an imager 200, a register 201, an image processor 202, a timer 203, a PMU 204, a CPU 205, and a control IF 206. These elements may be referred to with terms such as “block” or “circuit” appended to their tail as long as there is no inconsistency. The same applies to each element of an in-AP PD 30 of an AP device 3 described later.

The imager 200 generates and outputs a pixel signal for obtaining data (image data) of an image including a subject. For example, the imager 200 includes a pixel array unit, a peripheral circuit, and the like. The pixel array unit includes a plurality of pixels. Each pixel includes a photoelectric conversion unit such as a photodiode, a transistor for extracting charges accumulated in the photoelectric conversion unit and converting the charges into an electric signal (pixel signal), and the like. The peripheral circuit drives each pixel so as to obtain a pixel signal from each pixel. The pixel signals obtained in this manner are, for example, transmitted to the image processor 202.

The register 201 is used to perform various settings in the sensor device 2. The setting is performed by rewriting the register 201. Configurations of various known register circuits or the like may be adopted. Details of the register 201 will be described later.

The image processor 202 processes pixel signals from the imager 200. For example, the image processor 202 generates image data on the basis of pixel signals from respective pixels obtained in the imager 200. The image data in this example is image data (Raw data) before being subjected to conversion processing by a data conversion circuit 211 of the in-sensor PD 21 described later.

The timer 203 manages a timer (Timer).

The PMU 204 is a power management unit. The PMU 204 controls each power supply that supplies power to each power domain in the sensor device 2. The control by the PMU 204 includes control of power-on and power-off of the in-sensor PD 20, control of power-on and power-off of the in-sensor PD 21, control of power-on and power-off of the in-sensor PD 22, and others. The PMU 204 can individually control power-on and power-off of each in-sensor PD.

The CPU 205 executes various types of arithmetic processing. Examples of the arithmetic processing by the CPU 205 include software (SW) calculation processing, interrupt handling, and others.

The control IF 206 is an interface for communicating with a device outside the sensor device 2, in this example, the AP device 3, regarding the control of the sensor system 1, more specifically, the control of the sensor device 2 and the AP device 3. As the control IF 206, a general-purpose interface such as I2C, I3C, SPI, SPMI, or UART may be used, or a dedicated (proprietary) interface may be used.

The sensor device 2 includes a TxIF circuit 23. The TxIF circuit 23 is an interface circuit that transmits (a signal (for example, a differential signal)) of image data to the AP device 3 and is provided across the in-sensor PD 21 and the in-sensor PD 22.

The TxIF circuit 23 transmits image data in accordance with a communication standard (or a communication protocol or the like). A specific communication standard is not particularly limited, and various known communication standards may be used.

Among the in-sensor PD 21 and the in-sensor PD 22 across which the TxIF circuit 23 is provided, the in-sensor PD 21 provides a layer (communication layer) higher than the physical layer. The in-sensor PD 22 provides a physical layer.

When viewed along the flow of image data, the in-sensor PD 21 is located between the in-sensor PD 20 and the in-sensor PD 22. The in-sensor PD 22 is located on the opposite side to the in-sensor PD 20 across the in-sensor PD 21 and is located between the in-sensor PD 21 and the AP device 3 (more specifically, an in-AP PD 32 of an RxIF circuit 33 described later).

Specifically, the TxIF circuit 23 includes the data conversion circuit 211, the LINK circuit 212, an ISO circuit 213, and a PHY circuit 220.

The data conversion circuit 211 and the LINK circuit 212 are included in the in-sensor PD 21 and provide a circuit of a layer higher than the physical layer (for example, a link layer circuit). The data conversion circuit 211 converts the image data (Raw data) from the image processor 202 into image data having been subjected to Byte conversion. The LINK circuit 212 packetizes the image data from the data conversion circuit 211 and generates packet data and symbol data.

The ISO circuit 213 is also included in the in-sensor PD 21 in this example. The ISO circuit 213 provides electrical isolation between the in-sensor PD 21 and the in-sensor PD 22 with respect to data transferred from the LINK circuit 212 to a PHYDig circuit 221 of the PHY circuit 220.

The PHY circuit 220 is included in the in-sensor PD 22 and provides a physical layer circuit. The PHY circuit 220 converts the signal from the LINK circuit 212 from a digital signal into an analog signal and transmits the analog signal to the AP device 3. In the PHY circuit 220, a circuit that processes the digital signal is referred to as the PHYDig circuit 221 in the drawing. A circuit that processes the analog signal is referred to as a PHYAnalog circuit 222 in the drawing.

Similarly to the sensor device 2, the AP device 3 includes a plurality of PDs of which power-on and power-off can be individually controlled. In the example illustrated in FIG. 1, the AP device 3 includes an in-AP PD 30, an in-AP PD 31 (first in-AP PD), and an in-AP PD 32 (second in-AP PD). In a case where they are not particularly distinguished from each other, they are simply referred to as in-AP PDs.

The AP device 3 includes an RxIF circuit 33. The RxIF circuit 33 is an interface circuit that receives the image data from the TxIF circuit 23 of the sensor device 2 and is provided across the in-AP PD 31 and the in-AP PD 32.

The RxIF circuit 33 receives the image data from the TxIF circuit 23 in accordance with a communication standard similar to that of the TxIF circuit 23 of the sensor device 2 described above.

Among the in-AP PD 31 and the in-sensor PD 22 in which the RxIF circuit 33 is included, the in-AP PD 31 provides a layer higher than the physical layer. The in-AP PD 32 provides a physical layer.

When viewed along the flow of image data, the in-AP PD 31 is located between the in-AP PD 30 and the in-AP PD 32. The in-AP PD 32 is located on the opposite side to the in-AP PD 30 across the in-AP PD 31 and is located between the in-AP PD 31 and the sensor device 2 (more specifically, the in-sensor PD 22 of the TxIF circuit 23).

Specifically, the RxIF circuit 33 includes a data conversion circuit 311, a LINK circuit 312, an ISO circuit 313, and a PHY circuit 320.

The PHY circuit 320 is included in the in-AP PD 32 and provides a physical layer circuit. The PHY circuit 320 converts (the signal of) the image data from the TxIF circuit 23 of the sensor device 2 from an analog signal to a digital signal. In the PHY circuit 320, a circuit that processes an analog signal is referred to as a PHYAnalog CIRCUIT 322 in the drawing. A circuit that processes a digital signal is referred to as a PHYDig CIRCUIT 321 in the drawing.

The ISO circuit 313, the LINK circuit 312, and the data conversion circuit 311 are included in the in-AP PD 31 and provide a circuit (for example, a link layer circuit) of a layer higher than the physical layer. The ISO circuit 313 provides electrical isolation between the in-AP PD 31 and the in-AP PD 32 with respect to data transferred from the PHY circuit 320 to the LINK circuit 312. The LINK circuit 312 extracts packet data (including, for example, image data after Byte conversion), symbol data, and the like indicated by the signal from the PHY circuit 320. The data conversion circuit 311 converts the data extracted by the LINK circuit 312 into data before Byte conversion. For example, the same image data as the image data obtained in the image processor 202 of the sensor device 2 is obtained.

The in-AP PD 30 includes a register 301, an image processor 302, a timer 303, a PMU 304, a CPU 305, and a control IF 306.

The register 301 is used to perform various settings in the AP device 3. The setting is performed by rewriting the register 301. Configurations of various known register circuits or the like may be adopted. Details of the register 301 will be described later.

The image processor 302 processes image data received by the RxIF circuit 33 described later. Various types of processing depending on the use (application) of the AP device 3 may be executed.

The timer 303 manages a timer.

The PMU 304 is a power management unit and controls each power supply that supplies power to each power domain in the AP device 3. Examples of the control by the PMU 304 include control of power-on and power-off of the in-AP PD 30, control of power-on and power-off of the in-AP PD 31, and control of power-on and power-off of the in-AP PD 32. The PMU 304 can individually control power-on and power-off of each of the in-AP PDs.

The CPU 305 executes various types of arithmetic processing. Examples of the arithmetic processing by the CPU 205 include software (SW) calculation processing, interrupt handling, and others.

The control IF 306 is an interface for communicating with a device outside the AP device 3, in this example, the sensor device 2, regarding the control of the sensor system 1, more specifically, the control of the sensor device 2 and the AP device 3. As the control IF 306, similarly to the control IF 206 of the sensor device 2 described above, a general-purpose interface such as I2C, I3C, SPI, SPMI, or VART may be used, or a dedicated (proprietary) interface may be used.

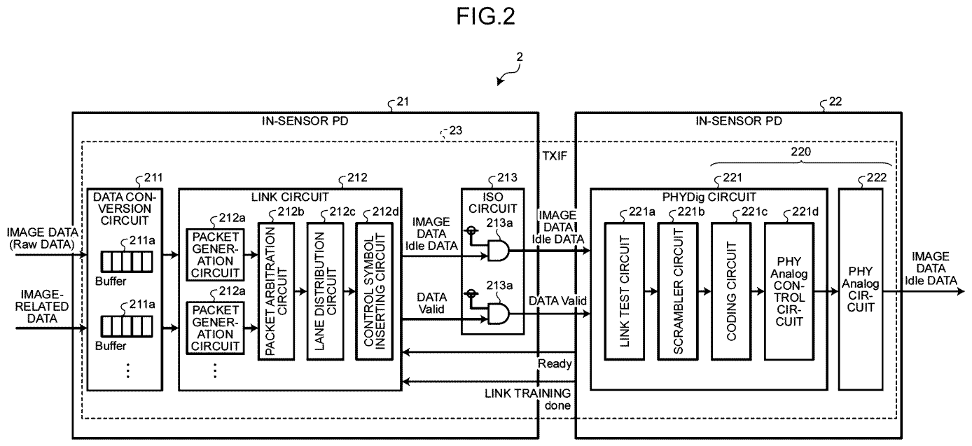

FIG. 2 is a diagram illustrating an example of the TxIF circuit 23. An exemplary detailed configuration of the data conversion circuit 211, the LINK circuit 212, the ISO circuit 213, and the PHYDig circuit 221 among the components of the TxIF circuit 23 described above will be described. In this example, it is based on a premise that a multi-lane configuration is implemented in the TxIF circuit 23.

The data conversion circuit 211 includes a plurality of buffers 211a. As the plurality of buffers 21la, two buffers 211a are illustrated as an example in FIG. 2. Image data (Raw data) or image-related data (data attached to the image) is temporarily stored in a buffer 211a and converted into Byte data.

The LINK circuit 212 includes a plurality of packet generation circuits 212a, a packet arbitration circuit 212b, a lane distribution circuit 212c, and a control symbol inserting circuit 212d.

The plurality of packet generation circuits 212a are provided corresponding to the plurality of buffers 211a of the data conversion circuit 211. Each of the packet generation circuits 212a generates a packet on the basis of the Byte data from a corresponding buffer 211a.

The packet arbitration circuit 212b arbitrates transmission of packets generated by the respective packet generation circuits 212a. Each packet is sent to the lane distribution circuit 212c so as to avoid a transmission collision of packets.

The lane distribution circuit 212c assigns the packets from the packet arbitration circuit 212b to a plurality of lanes. The lane distribution circuit 212c is used in a case where the multi-lane configuration is implemented as described above.

The control symbol inserting circuit 212d inserts a control symbol into each packet assigned to the lane distribution circuit 212c. The packets after insertion of the control symbol are also referred to as image data. The image data is sent to the PHY circuit 220 via the ISO circuit 213.

The ISO circuit 213 includes ISO cells 213a. An ISO cell 213a is connected between the LINK circuit 212 and the PHY circuit 220.

When the power supply of the in-sensor PD 21 is turned on, the ISO cell 213a transmits a data signal from the LINK circuit 212 to the PHY circuit 220.

The ISO cell 213a electrically isolates the LINK circuit 212 from the PHY circuit 220 when the power supply of the in-sensor PD 21 is turned off. This separation is performed in such a manner that the LINK circuit 212 whose power is turned off does not affect the operation of the PHY circuit 220. For example, the ISO cell 213a is configured in such a manner that the impedance when the ISO circuit 213 (and the LINK circuit 212) is viewed from the PHY circuit 220 is stabilized (for example, opened).

The PHYDig circuit 221 includes a link test circuit 221a, a scrambler circuit 221b, a coding circuit 221c, and a PHYAnalog control circuit 221d.

The link test circuit 221a generates a pattern used to establish communication (establish a link) between the TxIF circuit 23 and the RxIF circuit 33 (FIG. 1) or generates a test pattern. Examples of the pattern include a pattern for equalizing, a pattern for bit lock, a pattern for symbol boundary detection, a pattern for clock data recovery (CDR) lock, and the like.

The scrambler circuit 221b scrambles data from an upper layer (the LINK circuit 212 in this example). Processing may be bypassed for certain symbols.

The coding circuit 221c includes, for example, a line coding circuit and a precoding circuit. The line coding circuit is an encoding circuit such as 8b/10b, 128/130b, or 128b/132b. The precoding circuit is a Countermeasure circuit that varies bit positions so as not to disable reception due to a burst error. Processing may be bypassed for certain symbols.

The PHYAnalog control circuit 221d is an interface circuit for controlling the PHYAnalog circuit 222.

Note that FIG. 2 also illustrates, as data exchanged between the in-sensor PD 21 and the in-sensor PD 22, Idle data, data Valid, Ready, and link training Done in addition to the image data. The Idle data is transmitted when there is no image data and is transmitted as a signal of a predetermined pattern (Idle pattern). The data Valid indicates whether or not the data is valid. Ready indicates that the PHY circuit 220 of the in-sensor PD 22 is in a Ready state. The link training Done indicates that a link training is completed.

In the sensor system 1 described above, image data is transmitted from the sensor device 2 to the AP device 3 via the TxIF circuit 23 and the RxIF circuit 33. Image data is not always transmitted, and thus there is a period in which no image data is transmitted. This period is referred to as a blank period. Note that the transmission of the image data from the sensor device 2 to the AP device 3 may be referred to as a transfer. Data to be transferred may be referred to as transfer data or the like.

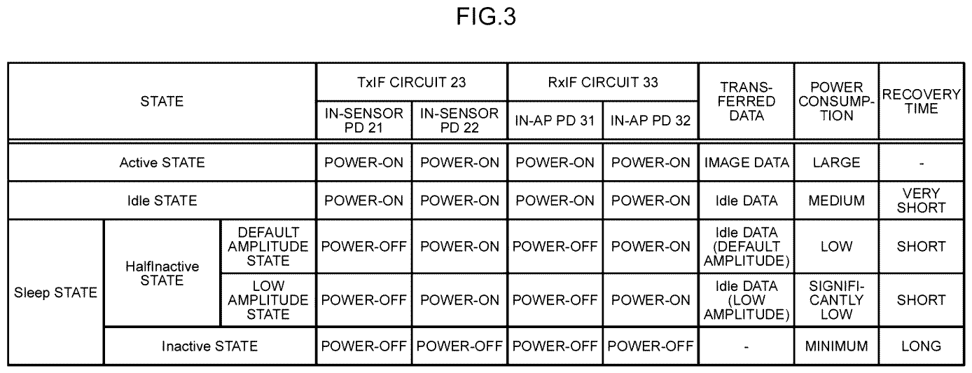

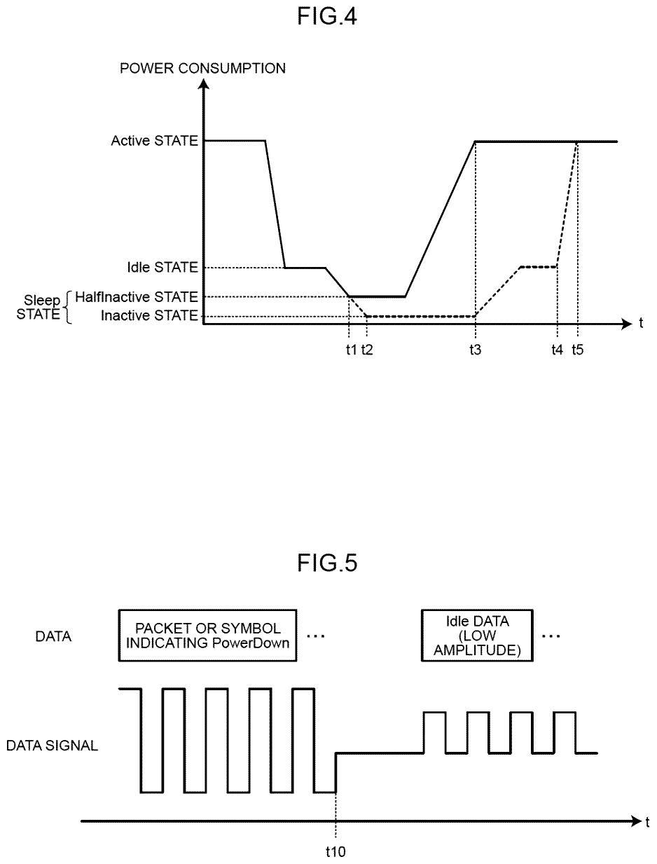

It is conceivable that the power consumption of the TxIF circuit 23 and the RxIF circuit 33 is reduced in a blank period. For example, the power consumption of the TxIF circuit 23 is reduced by shutting down the power supply of the in-sensor PD 21 or shutting down the power supply of the in-sensor PD 22. Similarly, the power consumption of the RxIF circuit 33 is reduced by shutting down the power supply of the in-AP PD 31 or shutting down the power supply of the in-sensor PD 22. This will be described also with reference to FIGS. 3 and 4.

FIGS. 3 and 4 are diagrams illustrating examples of states (operations) of the TxIF circuit 23 and the RxIF circuit 33. FIG. 3 illustrates power-on or power-off of the in-sensor PD 21, the in-sensor PD 22, the in-AP PD 31, and the in-AP PD 32, transfer data, the power consumption, and recovery time for each state in association with each other. FIG. 4 is a graph schematically illustrating the relationship between the recovery time from an Active state and the power consumption. The horizontal axis of the graph represents time t, and the vertical axis represents the power consumption.

Each of the TxIF circuit 23 and the RxIF circuit 33 can transition between a plurality of states. Specifically, the state of the TxIF circuit 23 includes an Active state, an Idle state, and a Sleep state. Similarly, the state of the RxIF circuit 33 includes the Active state, the Idle state, and the Sleep state. The TxIF circuit 23 and the RxIF circuit 33 perform state transition so as to be in the same state.

The Active state of the TxIF circuit 23 is a state in which the power supplies of both the in-sensor PD 21 and the in-sensor PD 22 are turned on. The Active state of the RxIF circuit 33 is a state in which the power supplies of both the in-AP PD 31 and the in-AP PD 32 are turned on. The Active state is a state in which image data is being transferred. The RxIF circuit 33 transmits the image data, and the RxIF circuit 33 receives the image data from the TxIF circuit 23. The power consumption in the Active state is larger than the power consumption in other states.

The recovery time indicates a recovery time from a power shutdown, and more specifically, indicates a time required to recover to the Active state. In the Active state, there is no recovery time (zero).

The Idle state of the TxIF circuit 23 is a state in which the power supplies of both the in-sensor PD 21 and the in-sensor PD 22 are turned on. The Idle state of the RxIF circuit 33 is a state in which the power supplies of both the in-AP PD 31 and the in-AP PD 32 are turned on.

The Idle state is a state in which Idle data is being transferred. The TxIF circuit 23 transmits the Idle data, and the RxIF circuit 33 receives the Idle data from the TxIF circuit 23. The power consumption in the Idle state is smaller than the power consumption in the Active state. The recovery time from the Idle state to the Active state (time t4 to time t5) is very short.

The Sleep state of the TxIF circuit 23 is a state in which the power consumption is reduced as compared to that in the Idle state. The same applies to the Sleep state of the RxIF circuit 33. In the present embodiment, the Sleep state includes a HalfInactive state and an Inactive state.

The HalfInactive state of the TxIF circuit 23 is a state in which the power supply of the in-sensor PD 21 is turned off while the power supply of the in-sensor PD 22 is turned on. The HalfInactive state of the RxIF circuit 33 is a state in which the power supply of the in-AP PD 31 is turned off while the power supply of the in-AP PD 32 is turned on. In the HalfInactive state, Idle data is transferred. This is because the power supplies of the in-sensor PD 22 and the in-AP PD 32 are turned on, and thus the PHY circuit 220 of the TxIF circuit 23 and the PHY circuit 320 of the RxIF circuit 33 operate. The TxIF circuit 23 (the PHY circuit 220 thereof) transmits Idle data. The RxIF circuit 33 (the PHY circuit 320 thereof) receives the Idle data from the TxIF circuit 23. The power consumption in the HalfInactive state is smaller than the power consumption in the Idle state. The recovery time from the HalfInactive state to the Active state (time t1 to time t3) is longer than the recovery time from the Idle state (time t4 to time t5) but shorter than the recovery time from the Inactive state (time t2 to time t5).

The Inactive state of the TxIF circuit 23 is a state in which the power supplies of both the in-sensor PD 21 and the in-sensor PD 22 are turned off. The Inactive state of the RxIF circuit 33 is a state in which the power supplies of both the in-AP PD 31 and the in-AP PD 32 are turned off. In the Inactive state, no data is transferred. The power consumption in the Inactive state is smaller than the power consumption in the HalfInactive state. The recovery time from the Inactive state to the Active state (time t2 to time t5) is longer than the recovery time from other states (the longest).

The reason the recovery time from the HalfInactive state to the Active state is shorter than the recovery time from the Inactive state to the Active state will be described. In the Inactive state, the TxIF circuit 23 and the RxIF circuit 33 do not communicate at all, and therefore communication therebetween is not established. In order to return from such an Inactive state to the Active state, link training for establishing communication between the TxIF circuit 23 and the RxIF circuit 33 needs to be performed. That is, the transition from the Inactive state to the Active state includes link training. Meanwhile, in the HalfInactive state, the communication between the TxIF circuit 23 and the RxIF circuit 33 is kept. established. Since the transition from the HalfInactive state to the Active state does not include the link training, the recovery time is shortened.

The HalfInactive state will be further described. In the example illustrated in FIG. 3, the HalfInactive state includes a default amplitude state and a low amplitude state.

In the default amplitude state, Idle data having the default amplitude is transferred. The signal of the Idle data having the default amplitude has, for example, the same amplitude value as the amplitude value of the signal of the Idle data transferred in the Idle state. The TxIF circuit 23 transmits the Idle data having the default amplitude. The RxIF circuit 33 receives the Idle data having the default amplitude from the TxIF circuit 23.

In the low amplitude state, Idle data having a low amplitude is transferred. The signal of the Idle data having the low amplitude has an amplitude value smaller than the amplitude value of the signal of the Idle data having the default amplitude. The power consumption in the low amplitude state is smaller than the power consumption in the default amplitude state. The TxIF circuit 23 transmits the Idle data having the low amplitude. The RxIF circuit 33 receives the Idle data having the low amplitude from the TxIF circuit 23.

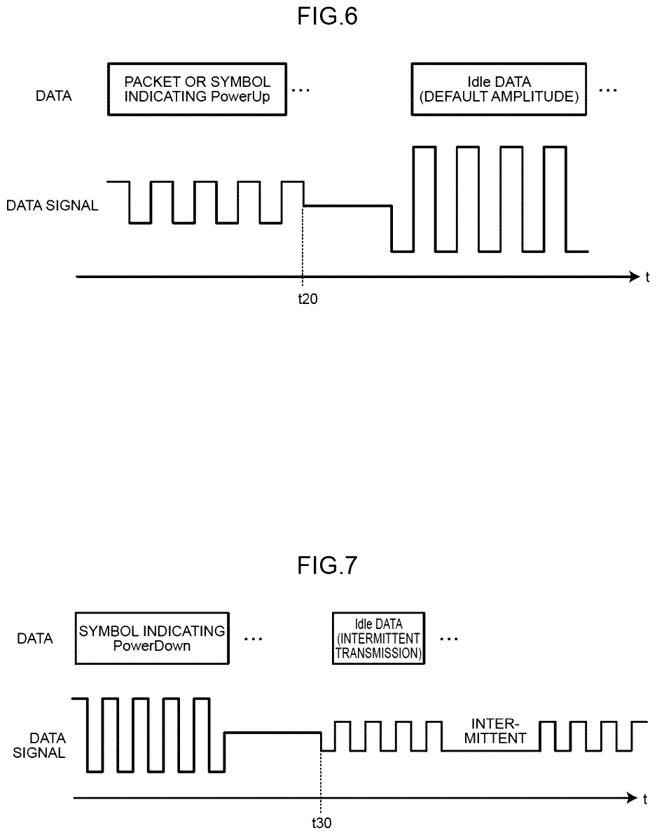

When the TxIF circuit 23 and the RxIF circuit 33 transition to the low amplitude state or transition to the default amplitude state, a packet or a symbol notifying the transition may be transmitted from the TxIF circuit 23 to the RxIF circuit 33. This will be described also with reference to FIGS. 5 and 6.

FIGS. 5 and 6 are diagrams illustrating examples of transitions to the low amplitude state and the default amplitude state.

In the example illustrated in FIG. 5, until time t10, the TxIF circuit 23 transmits a packet or a symbol (a signal thereof) indicating transition to PowerDown (power reduction), more specifically, the low amplitude state, to the RxIF circuit 33. The RxIF circuit 33 receives the packet or the symbol from the TxIF circuit 23. Then, the TxIF circuit 23 transmits the Idle data having the low amplitude to the RxIF circuit 33. The RxIF circuit 33 receives the Idle data having the low amplitude from the TxIF circuit 23.

In the example illustrated in FIG. 6, until time t20, the TxIF circuit 23 transmits a packet or a symbol indicating PowerUp (power increase) to the RxIF circuit 33. The RxIF circuit 33 receives the packet or the symbol from the TxIF circuit 23. Then, the TxIF circuit 23 transmits the Idle data having the default amplitude to the RxIF circuit 33. The RxIF circuit 33 receives the Idle data having the default amplitude from the TxIF circuit 23.

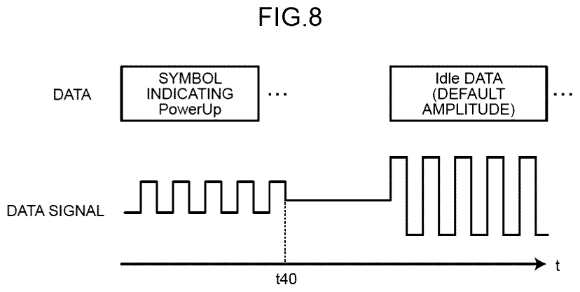

In one embodiment, the TxIF circuit 23 and the RxIF circuit 33 may intermittently operate in the Idle state. It is possible to further reduce power consumption. That is, the transmission of the Idle data by the TxIF circuit 23 may include intermittent transmission. The reception of the Idle data from the TxIF circuit 23 by the RxIF circuit 33 may include intermittent reception. This will be described also with reference to FIGS. 7 and 8.

FIGS. 7 and 8 are diagrams illustrating examples of intermittent operation of the TxIF circuit 23 and the RxIF circuit 33.

In the example illustrated in FIG. 7, until time t30, the TxIF circuit 23 transmits a symbol (a signal thereof) indicating transition to PowerDown, more specifically, the low amplitude state and the intermittent operation in this example, to the RxIF circuit 33. The RxIF circuit 33 receives the symbol from the TxIF circuit 23. Then, the TxIF circuit 23 intermittently transmits the Idle data having a low amplitude to the RxIF circuit 33. The RxIF circuit 33 intermittently receives the Idle data having the low amplitude from the TxIF circuit 23. For example, self-oscillation of clock and data recovery (CDR) on the RxIF circuit 33 side may be used.

In the example illustrated in FIG. 8, until time t40, the TxIF circuit 23 transmits a symbol indicating transition to PowerUp, more specifically, the default amplitude state that is not the intermittent operation to the RxIF circuit 33 in this example. The RxIF circuit 33 receives the symbol from the TxIF circuit 23. Then, the TxIF circuit 23 transmits the Idle data having the default. amplitude to the RxIF circuit 33. The RxIF circuit 33 receives the Idle data having the default amplitude from the TxIF circuit 23.

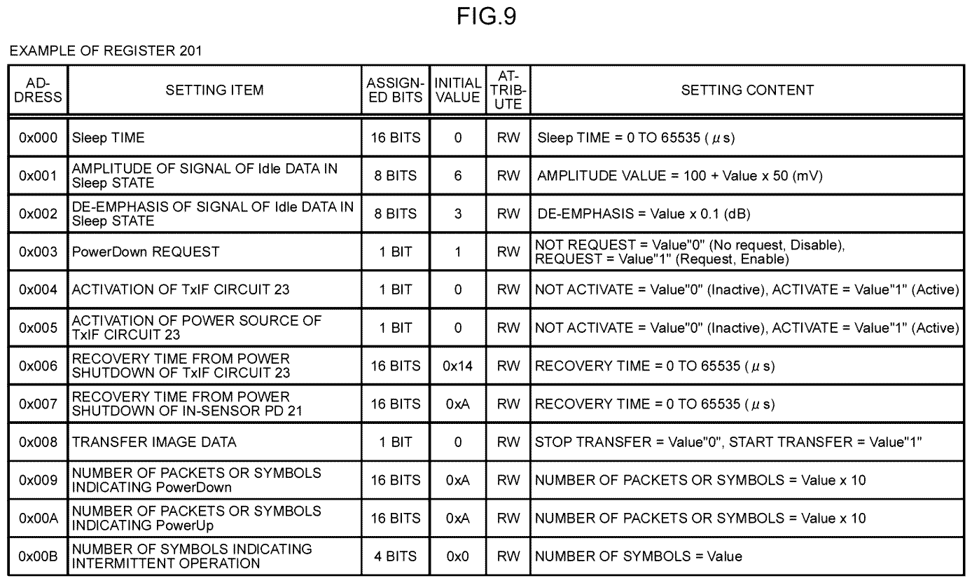

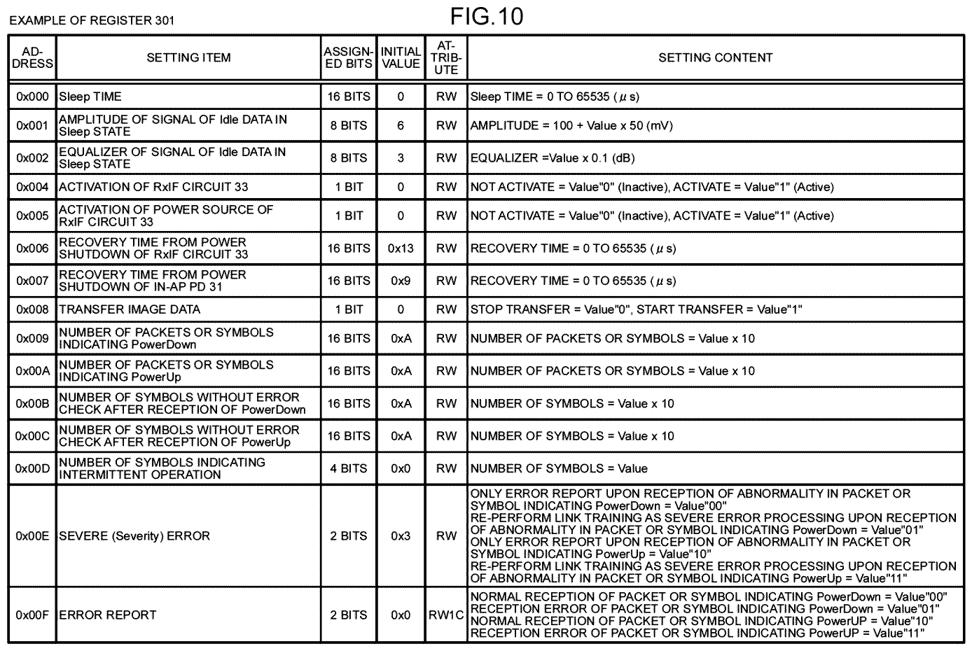

Referring back to FIG. 1, the register 201 of the sensor device 2 and the register 301 of the AP device 3 are set, for example, in order to control the states of the TxIF circuit 23 and the RxIF circuit 33 as described above. This will be described also with reference to FIGS. 9 and 10.

FIG. 9 is a table illustrating an example of the register 201. A setting item, assigned bits (bit assign), the initial value (initial Value), an attribute (Attribute), and setting content are indicated for each address. Description will be given in order along the address.

In address 0x000, the Sleep time, namely, the time (length) for setting the TxIF circuit 23 to the Sleep state is written. In this example, a Sleep time of 0 to 65535 (μs) is set using assigned sixteen bits. The content of the initial value is as the term indicates, and the attribute RW indicates that the value can be read (R) and written (W).

In address 0x001, the amplitude of the signal of the Idle data in the Sleep state, namely, the amplitude value of the signal of the Idle data transmitted by the TxIF circuit 23 in the Sleep state is written. In this example, an amplitude value of 100+Value×50 (mV) is set using assigned eight bits. The value Value denotes the value that has been written. Not only the Idle data but also a packet or a symbol indicating a Sleep transition (indicating PowerDown) may be transmitted with the set amplitude. Bit field information may be embedded in the packet or the symbol.

A de-emphasis of the signal of the Idle data in the Sleep state is written to address 0x002. In this example, a de-emphasis of Value×0.1 (dB) is set using assigned eight bits.

A PowerDown request is written to address 0x003.In this example, whether PowerDown is not requested (No Request Disable) or is requested (Request Enable) is set using one assigned bit. After setting this register and requesting PowerDown, when the above-described Sleep time expires, the setting is cleared (no request is made).

In address 0x004, activation of the TxIF circuit 23 is written. In this example, whether the TxIF circuit 23 is not activated (set to the Inactive state) or activated (set to the Active state) is set using one assigned bit. Note that, when the TxIF circuit 23 is activated, link training is started.

In address 0x005, activation of the power supply of the TxIF circuit 23 is written. In this example, whether the power supply of the TxIF circuit 23 is not activated (set to the Inactive state) or activated (set to the Active state) is set using one assigned bit.

In address 0x006, a recovery time from a power shutdown of the TxIF circuit 23 is written. In this example, a recovery time of 0 to 65535 (μs) is set using assigned sixteen bits. This value (for example, the initial value) may be calculated and set on the basis of a power-on sequence by the PMU 204, a blank period, and the like. Note that the attribute may be RO (read only).

In address 0x007, a recovery time from a power shutdown of the in-sensor PD 21 is written. In this example, the recovery time of 0 to 65535 (μs) is written using assigned sixteen bits. This value (for example, the initial value) may also be calculated and set on the basis of a power-on sequence by the PMU 204, a blank period, and the like. Note that the attribute may be RO.

In address 0x008, a transfer of image data, namely, transmission of the image data by the TxIF circuit 23 is written. In this example, whether the image data is not transferred (stop transfer) or transferred (start transfer) is set using one assigned bit.

In address 0x009, the number of packets or symbols indicating PowerDown is written. In this example, the number of packets or symbols of Value×10 is set using assigned sixteen bits.

In address 0x00A, the number of packets or symbols indicating PowerUp is written. The TxIF circuit 23 transmits the packets or the symbols to the RxIF circuit 33 in order to notify of PowerUp. In this example, the number of packets or symbols of Value×10 is written using assigned sixteen bits.

In address 0x00B, the number of symbols indicating intermittent operation is written. In this example, the number of symbols equal to the value of Value is set using assigned four bits.

Not to mention that various items other than the items illustrated in FIG. 9 may also be set. Examples of other items include the amplitude, a de-emphasis, an equalizer for reception, and the like of the signal of the image data in the Active state.

FIG. 10 is a table illustrating an example of the register 301.

The Sleep time, namely, the time for bringing the RxIF circuit 33 into the Sleep state, is written to address 0x000. In this example, a Sleep time of 0 to 65535 (μs) is set using assigned sixteen bits.

In address 0x001, the amplitude of the signal of the Idle data in the Sleep state, namely, the amplitude value of the signal of the Idle data received by the RxIF circuit 33 in the Sleep state is written. In this example, an amplitude value of 100+Value×50 (mV) is set using assigned eight bits. The value Value denotes the value that has been written. Not only the Idle data but also a packet or a symbol indicating a Sleep transition (indicating PowerDown) may be received with the set amplitude.

An equalizer of the signal of the Idle data in the Sleep state is written to address 0x002. In this example, an equalizer of Value×0.1 (dB) is set using assigned eight bits.

In address 0x004, the activation of the RxIF circuit 33 is written. In this example, whether the RxIF circuit 33 is not activated (set to the Inactive state) or activated (set to the Active state) is set using one assigned bit. Note that, when the RxIF circuit 33 is activated, link training is started.

In address 0x005, activation of the power supply of the RxIF circuit 33 is written. In this example, whether the power supply of the RxIF circuit 33 is not activated (set to the Inactive state) or activated (set to the Active state) is set using one assigned bit.

In address 0x006, a recovery time from a power shutdown of the RxIF circuit 33 is written. In this example, a recovery time of 0 to 65535 (μs) is set using assigned sixteen bits. This value (for example, the initial value) may be calculated and set on the basis of a power-on sequence by the PMU 304, a blank period, and the like. Note that the attribute may be RO.

In address 0x007, a recovery time from a power shutdown of the in-AP PD 31 is written. In this example, a recovery time of 0 to 65535 (μs) is set using assigned sixteen bits. This value (for example, the initial value) may be calculated and set on the basis of a power-on sequence by the PMU 304, a blank period, and the like. Note that the attribute may be RO.

In address 0x008, a transfer of image data, namely, transmission of the image data by the RxIF circuit 33 is written. In this example, whether the image data is not transferred (stop transfer) or transferred (start transfer) is set using one assigned bit.

In address 0x009, the number of packets or symbols indicating PowerDown is written. In this example, the packets or the symbols are received by the RxIF circuit 33 from the TxIF circuit 23. The number of packets or symbols is set to be the same as the number of packets or symbols indicating PowerDown in FIG. 9 described above.

In address 0x00A, the number of packets or symbols indicating PowerUp is written. In this example, the packets or the symbols are received by the RxIF circuit 33 from the TxIF circuit 23. The number of packets or symbols is set to be the same as the number of packets or symbols indicating PowerUp in FIG. 9 described above.

In address 0x00B, the number of symbols without an error check after PowerDown reception is written. In this example, the number of symbols of Value×10 is written using assigned sixteen bits. In the case where this number is set, the RxIF circuit 33 does not perform an error check on the set number of symbols among the packets or symbols indicating PowerDown transmitted from the TxIF circuit 23. Accordingly, there is a high possibility that the power consumption can be reduced or the processing speed can be increased. Note that there is a case where it is not possible to normally receive the total number of packets or symbols in a case where an amplitude change or the like occurs; however, such a problem can also be addressed by adopting a mechanism of detection with a number of packets or symbols smaller than the total number.

In address 0x00C, the number of symbols without an error check after reception of PowerUp is written. In this example, the number of symbols of Value×10 is set using assigned sixteen bits. In the case where this number is set, the RxIF circuit 33 does not perform an error check on the set number of symbols among the packets or symbols indicating PowerUp transmitted from the TxIF circuit 23. Accordingly, there is a high possibility that the power consumption can be reduced or the processing speed can be increased.

In address 0x00D, the number of symbols indicating intermittent operation is written. This number is set to be the same as the number of symbols indicating the intermittent operation in FIG. 9 described above.

In address 0x00E, processing when a severe (Severity) error, more specifically, abnormality of a packet or a symbol indicating PowerDown or PowerUp is received is written. In this example, whether to send only an error report or to re-perform the link training as Severe error processing is set using assigned two bits.

In address 0x00F, an error report, more specifically, the presence or absence of a reception error of a packet or a symbol indicating PowerDown or PowerUp is written. In this example, whether the packet or the symbol has been normally received or a reception error has occurred is set using assigned two bits. The attribute is RWIC.

Referring back to FIG. 1, for example, by setting the items of the register 201 and the register 301 as described above, the states of the TxIF circuit 23 and the RxIF circuit 33 are controlled. In the sensor device 2, the PMU 204 and the CPU 205 can access the register 201 and set each item of the register 201. Furthermore, the CPU 305 of the AP device 3 can also set each item of the register 201 via the control IF 306 and the control IF 206 of the sensor device 2. In the AP device 3, the PMU 304 and the CPU 305 can access the register 301 and set each item of the register 301.

As described above, power-on and power-off of each of the in-sensor PD 20, the in-sensor PD 21, and the in-sensor PD 22 of the sensor device 2 can be individually controlled by the PMU 204. In addition, power-on and power-off of each of the in-AP PD 30, the in-AP PD 31, and the in-AP PD 32 of the AP device 3 can be individually controlled by the PMU 304.

In the present embodiment, the PMU 204 of the sensor device 2 may control the in-sensor PD 20 in such a manner that the power supply of the in-sensor PD 20 is constantly turned on regardless of whether image data is being transferred. On the other hand, the PMU 204 controls the in-sensor PD 21 and the in-sensor PD 22 in such a manner that the power supply of the in-sensor PD 21 and the in-sensor PD 22 is turned on or off.

Similarly, the PMU 304 of the AP device 3 may control the in-AP PD 30 in such a manner that the power supply of the in-AP PD 30 is constantly turned on regardless of whether image data is being transferred. On the other hand, the PMU 304 controls the in-AP PD 31 and the in-AP PD 32 in such a manner that the power supply of the in-AP PD 31 and the in-AP PD 32 is turned on or off.

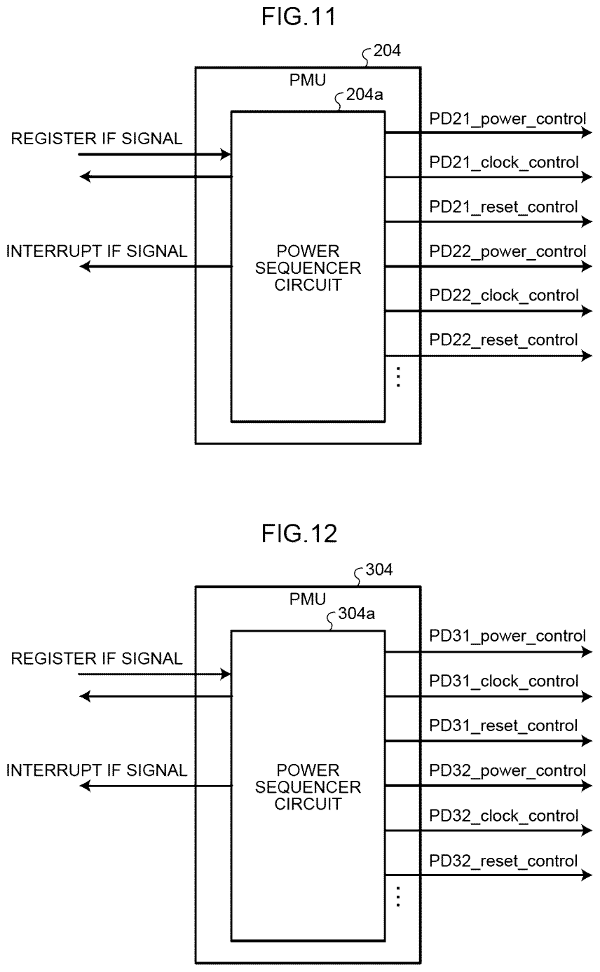

The PMU 204 and the PMU 304 will be described with reference to FIGS. 11 and 12.

FIG. 11 is a diagram illustrating an example of a schematic configuration of the PMU 204. The PMU 204 includes a power sequencer circuit 204a. The power sequencer circuit 204a controls a sequence of turning on and off the power supply of each of the in-sensor PDs of the sensor device 2. Several signals are illustrated which are input to the power sequencer circuit 204a or output from the power sequencer circuit 204a for this control.

A register IF signal is a signal for reading from the register 201 or writing to the register 201. An interrupt IF signal is a signal for notifying the CPU 205 of an interrupt.

PD21_Power_control is a signal for turning on or off the power supply of the in-sensor PD 21.

PD21_clock_control is a signal for controlling a clock of the in-sensor PD 21. This signal is used, for example, to stop the clock of the in-sensor PD 21 when the power supply is turned off. PD21_reset_control is a signal for controlling reset of the in-sensor PD 21. This signal is used, for example, to bring the in-sensor PD 21 into a reset state when the power supply is turned off.

Similarly, PD22_Power_control is a signal for turning on or off the power supply of the in-sensor PD 22. PD22_clock_control is a signal for controlling a clock of the in-sensor PD 22. PD22_reset_control is a signal for controlling reset of the in-sensor PD 22.

FIG. 12 is a diagram illustrating an example of a schematic configuration of the PMU 304. The basic configuration is similar to that of the PMU 204 described above. The PMU 304 includes a power sequencer circuit 304a, and some examples of input or output signals thereof are illustrated.

A register IF signal is a signal for reading from the register 301 or writing to the register 301. The interrupt IF signal is a signal for notifying the CPU 305 of an interrupt.

PD31_Power_control is a signal for turning on or off the power supply of the in-AP PD 31.

PD31_clock_control is a signal for controlling a clock of the in-AP PD 31. PD31_reset_control is a signal for controlling reset of the in-AP PD 31.

PD32_Power_control is a signal for turning on or off the power supply of the in-AP PD 32.

PD32_clock_control is a signal for controlling a clock of the in-AP PD 32. PD32_reset_control is a signal for controlling reset of the in-AP PD 32.

For example, the PMU 204 and the PMU 304 as described above control power-on and power-off of the in-sensor PD 21 and the in-sensor PD 22 of the sensor device 2 and the in-AP PD 31 and the RxIF circuit 33 of the AP device 3.

In the sensor system 1 having the configuration described above, in the sensor device 2, it is possible to individually control power-on and power-off of each of the in-sensor PD 21 and the in-sensor PD 22. In the AP device 3, power-on and power-off of the in-AP PD 31 and the in-AP PD 32 can be individually controlled. Therefore, it is possible to more finely control the reduction of the power consumption and the recovery time from a power shutdown than in a case where the power supply of the in-sensor PD 21, the in-sensor PD 22, the in-AP PD 31, and the in-AP PD 32 can only be turned on or off all together. As a result, it is possible to improve the trade-off between the reduction in power consumption due to a power shutdown and the recovery time from the power shutdown.

Specifically, in the sensor system 1, the power consumption is reduced by setting the TxIF circuit 23 of the sensor device 2 and the RxIF circuit 33 of the AP device 3 to the Sleep state. Furthermore, the Sleep state includes a HalfInactive state and an Inactive state. In the HalfInactive state, although not as much power consumption reduction effect as that in the Inactive state can be obtained, there is an advantage that the recovery time is short accordingly. Meanwhile, although the Inactive state has a longer recovery time than that in the HalfInactive state, there is an advantage that the power consumption reduction effect is large accordingly. By selectively using such a HalfInactive state and an Inactive state, it is possible to improve the trade-off between the reduction in power consumption and a recovery time from a power shutdown.

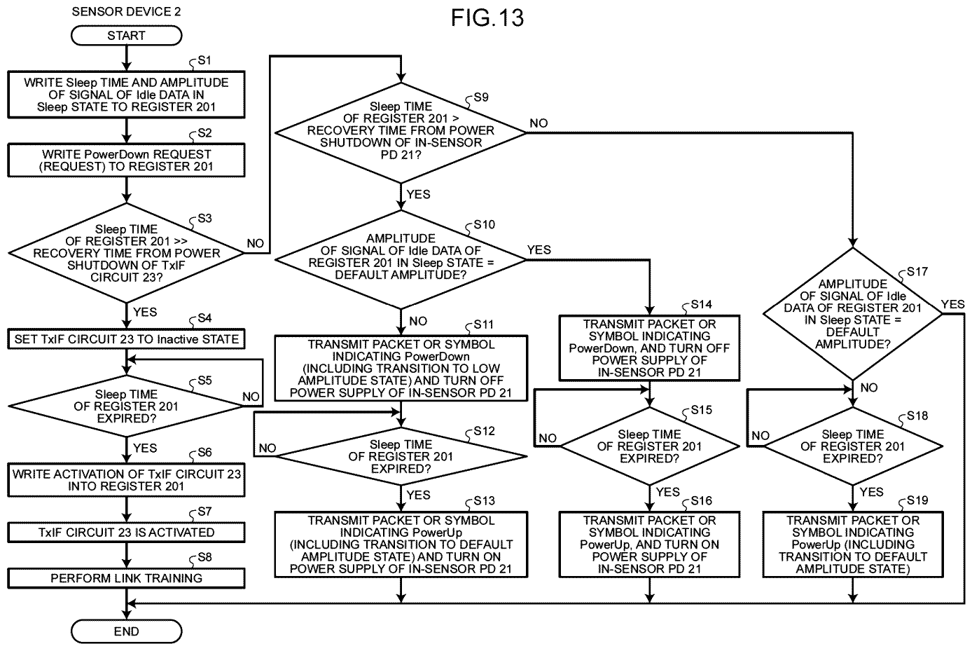

In one embodiment, the HalfInactive state and the Inactive state may be selectively used on the basis of the Sleep time set in the register 201 and the register 301, the recovery time from a power shutdown, and the like. The Sleep time may be calculated and set on the basis of the blank period. For example, in a case where the set Sleep time is sufficiently longer than the set recovery time (longer by more than or equal to a first threshold time), the states of the TxIF circuit 23 and the RxIF circuit 33 may transition to the Inactive state. In a case where the Sleep time is longer by more than a time (second threshold time (the second threshold time is shorter than the first threshold time)), the states of the TxIF circuit 23 and the RxIF circuit 33 may transition to the HalfInactive state. Some examples of specific processing will be described with reference also to FIGS. 13 to 16.

FIGS. 13 to 16 are flowcharts illustrating examples of processing (control method) executed in the sensor system 1. Description of the content overlapping with the above description will be omitted as appropriate.

FIG. 13 illustrates an exemplary processing flow in the sensor device 2. It is based on a premise that the power supplies of both the in-sensor PD 21 and the in-sensor PD 22 of the sensor device 2 are initially turned on and that the TxIF circuit 23 is in the Active state or the Idle state.

In step S1, the Sleep time and the amplitude of the signal of the Idle data in the Sleep state are written to the register 201. This processing is executed by, for example, the CPU 205 or the CPU 305 of the AP device 3.

In step S2, a PowerDown request (request) is written to the register 201. This process is also executed by the CPU 205 or the CPU 305 of the AP device 3, for example.

In step S3, it is determined whether or not the Sleep time of the register 201 (which is written in the register 201) is sufficiently longer than the recovery time from the power shutdown of the TxIF circuit 23. This processing is executed by the CPU 205, for example. Such a threshold determination as described above may be used, in which case it is determined that the Sleep time is sufficiently longer than the recovery time in a case where the Sleep time is longer than the set recovery time by more than or equal to the first threshold time (Sleep time recovery time 2 first threshold). If the Sleep time is sufficiently longer than the recovery time (step S3: Yes), the processing proceeds to step S4. If not (step S3: No), the processing proceeds to step S9.

In step S4, the TxIF circuit 23 is brought into the Inactive state. The power supplies of both the in-sensor PD 21 and the in-sensor PD 22 of the sensor device 2 are turned off. This processing is executed by the PMU 204.

In step S5, it is determined whether or not the Sleep time of the register 201 has expired. This processing is determined, for example, by the CPU 205 on the basis of an interrupt of the timer 203. If the Sleep time expires (step S5: Yes), the processing proceeds to step S6. If not (step S5: No), the processing of step S5 is repeated until the Sleep time expires.

In step S6, activation of the TxIF circuit 23 is written to the register 201. This processing is executed by the CPU 205, for example.

In step S7, the TxIF circuit 23 is activated. The power supplies of both the in-sensor PD 21 and the in-sensor PD 22 are turned on. This processing is executed by the PMU 204.

In step S8, link training is performed. Link training for establishing communication between the TxIF circuit 23 of the sensor device 2 and the RxIF circuit 33 of the AP device 3 is started and completed. The TxIF circuit 23 can recover to the Active state.

In step S9, it is determined whether or not the Sleep time of the register 201 is longer than the recovery time from the power-off of the in-sensor PD 21. This processing is executed by the CPU 205, for example. Such a threshold determination as described above may be used, in which case it is determined that the Sleep time is longer than the recovery time in a case where the Sleep time is longer than the set recovery time by more than or equal to the second threshold time (Sleep time—recovery time≥second threshold). If the Sleep time is longer than the recovery time (step S9: Yes), the processing proceeds to step S10. If not (step S9: No), the processing proceeds to step S17.

In step S10, it is determined whether or not the amplitude of the signal of the Idle data of the register 201 in the Sleep state is the default amplitude. This processing is executed by the CPU 205, for example. If the amplitude is the default amplitude (step S10: Yes), the processing proceeds to step S14. If not (step S10: No), the processing proceeds to step S11.

In step Sil, a packet or a symbol indicating PowerDown (including transition to the low amplitude state) is transmitted, and the power supply of the in-sensor PD 21 is turned off. These steps of processing are executed by, for example, the TxIF circuit 23 and the PMU 204.

In step S12, it is determined whether or not the Sleep time of the register 201 has expired. This processing is determined, for example, by the CPU 205 on the basis of an interrupt of the timer 203. If the Sleep time is expired (step S12: Yes), the processing proceeds to step S13. If not (step S12: No), the processing of step S12 is repeated until the Sleep time expires.

In step S13, a packet or a symbol indicating PowerUp (including transition to the default amplitude state) is transmitted, and the power supply of the in-sensor PD 21 is turned on. These steps of processing are executed by, for example, the TxIF circuit 23 and the PMU 204. The TxIF circuit 23 can recover to the Idle state or the Active state.

In step S14, a packet or a symbol indicating PowerDown is transmitted, and the power supply of the in-sensor PD 21 is turned off. These steps of processing are executed by, for example, the TxIF circuit 23 and the PMU 204.

In step S15, it is determined whether or not the Sleep time of the in-sensor PD 20 has expired. This processing is determined, for example, by the CPU 205 on the basis of an interrupt of the timer 203. If the Sleep time expires (step S15: Yes), the processing proceeds to step S16. If not (step S15: No), the processing of step S15 is repeated until the Sleep time expires.

In step S16, a packet or a symbol indicating PowerUp is transmitted, and the power supply of the in-sensor PD 21 is turned on. These steps of processing are executed by, for example, the TxIF circuit 23 and the PMU 204. The TxIF circuit 23 can recover to the Active state.

In step S17, it is determined whether or not the amplitude of the signal of the Idle data of the register 201 in the Sleep state is the default amplitude. This processing is executed by the CPU 205, for example. If the amplitude is the default amplitude (step S17: Yes), the processing of the flowchart ends. If not (step S17: No), the processing proceeds to step S18.

In step S18, it is determined whether or not the Sleep time of the register 201 has expired. This processing is determined, for example, by the CPU 205 on the basis of an interrupt of the timer 203. If the Sleep time has expired (step S18: Yes), the processing proceeds to step S19. If not (step S18: No), the processing of step S18 is repeated until the Sleep time expires.

In step S19, a packet or a symbol indicating PowerUp (including transition to the default amplitude state) is transmitted. The TxIF circuit 23 transmits an Idle signal having the default amplitude.

After the processing of step SB, step S13, step S16, step S17 (in the case of Yes), or step S19 described above is completed, the processing of the flowchart ends.

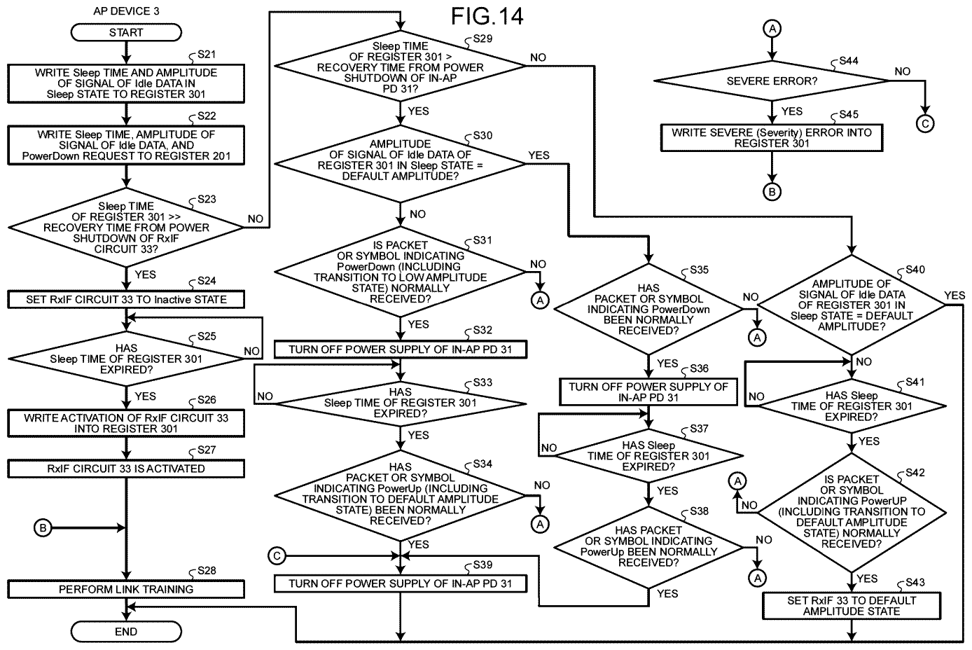

FIG. 14 illustrates an exemplary processing flow in the AP device 3. It is based on a premise that the power supplies of both the in-AP PD 31 and the in-AP PD 32 of the AP device 3 are initially turned on and that the RxIF circuit 33 is in the Active state or the Idle state.

In step S21, the Sleep time and the amplitude of the Idle signal in the Sleep state are written to the register 301. This processing is executed, for example, by the CPU 305 of the AP device 3.

In step S22, the Sleep time, the amplitude of the signal of the Idle data in the Sleep state, and the PowerDown request (request) are written to the register 201. These steps of processing are executed by, for example, the CPU 305 of the AP device 3. As described above, the CPU 305 can access the register 201 of the sensor device 2 via the control IF 306 and the control IF 206 of the sensor device 2.

In step S23, it is determined whether or not the Sleep time of the register 301 (which is set to the register 301) is sufficiently longer than the recovery time from the power shutdown of the RxIF circuit 33. This processing is executed, for example, by the CPU 305 of the AP device 3. Threshold determination similar to that in step S3 in FIG. 13 described above may be used. If the Sleep time is sufficiently longer than the recovery time (step S23: Yes), the processing proceeds to step S24. If not (step S23: No), the processing proceeds to step S29.

In step S24, the RxIF circuit 33 is brought into the Inactive state. The power supplies of both the in-AP PD 31 and the in-AP PD 32 of the AP device 3 are turned off. This processing is executed by the PMU 304.

In step S25, it is determined whether or not the Sleep time of the register 301 has expired. This processing is determined, for example, by the CPU 305 on the basis of an interrupt of the timer 303. If the Sleep time is expired (step S25: Yes), the processing proceeds to step S26. If not (step S25: No), the processing of step S25 is repeated until the Sleep time expires.

In step S26, activation of the RxIF circuit 33 is written to the register 301. This processing is executed by the CPU 305, for example.

In step S27, the RxIF circuit 33 is activated. The power supplies of both the in-AP PD 31 and the in-AP PD 32 are turned on. This processing is executed by the PMU 304.

In step S28, link training is performed. Link training for establishing communication between the RxIF circuit 33 of the AP device 3 and the TxIF circuit 23 of the sensor device 2 is started and completed. The RxIF circuit 33 can recover to the Active state.

In step S29, it is determined whether or not the Sleep time of the register 301 is longer than the recovery time from the power shutdown of the in-AP PD 31. This processing is executed by the CPU 305, for example. Threshold determination similar to that in step S9 in FIG. 13 described above may be used. If the Sleep time is longer than the recovery time (step S29: Yes), the processing proceeds to step S30. If not (step S29: No), the processing proceeds to step S40.

In step S30, it is determined whether or not the amplitude of the signal of the Idle data of the register 301 in the Sleep state is the default amplitude. This processing is executed by the CPU 305, for example. If the amplitude is the default amplitude (step S30: Yes), the processing proceeds to step S35. If not (step S30: No), the processing proceeds to step S31.

In step S31, it is determined whether or not a packet or a symbol indicating PowerDown (including transition to the low amplitude state) has been normally received. This processing is executed by the CPU 305, for example. If the packet or the symbol has been normally received (step S31: Yes), the processing proceeds to step S32. If not (step S31: No), the processing proceeds to step S44.

In step S32, the power supply of the in-AP PD 31 is turned off. This processing is executed by the PMU 304.

In step S33, it is determined whether or not the Sleep time of the register 301 has expired. This processing is determined, for example, by the CPU 305 on the basis of an interrupt of the timer 303. If the Sleep time is expired (step S33: Yes), the processing proceeds to step S34. If not (step S33: No), the processing of step S33 is repeated until the Sleep time expires.

In step S34, it is determined whether or not a packet or a symbol indicating PowerUp (including transition to the default amplitude state) has been normally received. This processing is executed by the CPU 305, for example. If the packet or the symbol has been normally received (step S34: Yes), the processing proceeds to step S39. If not (step S34: No), the processing proceeds to step S44.

In step S35, it is determined whether or not a packet or a symbol indicating PowerDown has been normally received. This processing is executed by the CPU 305, for example. If the packet or the symbol has been normally received (step S35: Yes), the processing proceeds to step S36. If not (step S35: No), the processing proceeds to step S44.

In step S36, the power supply of the in-AP PD 31 is turned off. This processing is executed by the PMU 304.

In step S37, it is determined whether or not the Sleep time of the register 301 has expired. This processing is determined, for example, by the CPU 305 on the basis of an interrupt of the timer 303. If the Sleep time is expired (step S37: Yes), the processing proceeds to step S38. If not (step S37: No), the processing of step S37 is repeated until the Sleep time expires.

In step S38, it is determined whether or not a packet or a symbol indicating PowerUp has been normally received. This processing is executed by the CPU 305, for example. If the packet or the symbol has been normally received (step S38: Yes), the processing proceeds to step S39. If not (step S38: No), the processing proceeds to step S44.

In step S39, the power supply of the in-AP PD 31 is turned on. This processing is executed by the PMU 304. The RxIF circuit 33 can recover to the Active state.

In step S40, it is determined whether or not the amplitude of the signal of the Idle data of the register 301 in the Sleep state is the default amplitude. This processing is executed by the CPU 305, for example. If the amplitude is the default amplitude (step S40: Yes), the processing of the flowchart ends. If not (step S40: No), the processing proceeds to step S41.

In step S41, it is determined whether or not the Sleep time of the register 301 has expired. This processing is determined, for example, by the CPU 305 on the basis of an interrupt of the timer 303. If the Sleep time expires (step S41: Yes), the processing proceeds to step S42. If not (step S41: No), the processing of step S41 is repeated until the Sleep time expires.

In step S42, it is determined whether or not a packet or a symbol indicating PowerUp (including transition to the default amplitude state) has been normally received. This processing is executed by the CPU 305, for example. If the packet or the symbol has been normally received (step S42: Yes), the processing proceeds to step S43. If not (step S42: No), the processing proceeds to step S44.

In step S43, the RxIF circuit 33 is brought into the default amplitude state. This processing is executed, for example, with the CPU 305 setting the register 301. The RxIF circuit 33 can recover to the Active state.

In step S44, it is determined whether or not an error in the previous processing is a severe error. This processing is executed by the CPU 305, for example. The error in this example is an error that the packet or the symbol in the previous step S31, step S34, step S35 or step S38, or step S42 has not been normally received. If the error is a severe error (step S44: Yes), the processing proceeds to step S45. If not (step S44: No), the processing proceeds to step S39 described earlier.

In step S45, a severe (Severity) error is written to the register 301. This processing is executed by the CPU 305, for example. Then, the processing proceeds to step S28 described earlier.

After the processing of step S28, step S39, step S40 (in the case of Yes), or step S43 described above is completed, the processing of the flowchart ends.

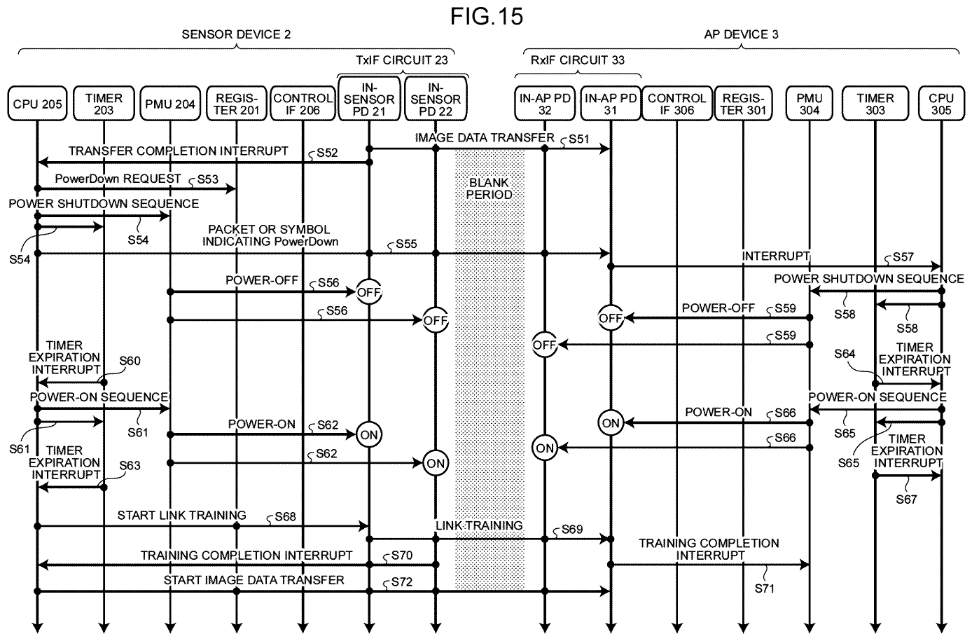

FIG. 15 illustrates an exemplary processing flow in a case where the TxIF circuit 23 of the sensor device 2 and the RxIF circuit 33 of the AP device 3 enter the Inactive state during a blank period.

The processing until the power shutdown is illustrated as steps S51 to S59.

In step S51, the TxIF circuit 23 transmits image data to the RxIF circuit 33 (image data transfer). The RxIF circuit 33 receives a data signal from the TxIF circuit 23.

In step S52, the TxIF circuit 23 (in-sensor PD 21) notifies the CPU 205 of a transfer completion interrupt indicating that the image data transfer in step S51 described above is completed.

In step S53, the CPU 205 writes a PowerDown request (request) to the register 201.

In this example, it is based on a premise that the Sleep time set in the register 201 and the register 301 is sufficiently longer than the recovery time from the power shutdown (step S3 described above in FIG. 13: Yes, step S23 in FIG. 14: Yes).

In step S54, the CPU 205 controls the PMU 204 and activates the timer 203 for PowerDown (power shutdown sequence).

In step S55, under the control of the CPU 205, the TxIF circuit 23 transmits a packet or a symbol indicating PowerDown to the RxIF circuit 33.

In step S56, the PMU 204 cuts off the power supply of both the in-sensor PD 21 and the in-sensor PD 22.

In step S57, the RxIF circuit 33 (in-AP PD 31) notifies the CPU 305 of an interrupt indicating that the packet or the symbol in step S55 has been received.

In step S58, the CPU 305 controls the PMU 304 and activates the timer 303 for PowerDown.

In step S59, the PMU 304 cuts off the power supply of both the in-AP PD 31 and the in-AP PD 32.

The TxIF circuit 23 and the RxIF circuit 33 enter the Inactive state. The subsequent processing up to power-on is illustrated as steps S60 to S67.

In step S60, the timer 203 notifies the CPU 205 of a timer expiration interrupt.

In step S61, the CPU 205 controls the PMU 204 and activates the timer 203 (power-on sequence).

In step S62, the PMU 204 turns on the power supply of both the in-sensor PD 21 and the in-sensor PD 22.

In step S63, the timer 203 notifies the CPU 205 of completion of a timer interrupt at the timing when the power-on sequence in step S61 described above is completed.

In step S64, the timer 303 notifies the CPU 305 of the timer completion interrupt.

In step S65, the CPU 305 controls the PMU 304 and activates the timer 303 (power-on sequence).

In step S66, the PMU 304 turns on the power supply of both the in-AP PD 31 and the in-AP PD 32.

In step S67, the timer 303 notifies the CPU 305 of completion of the timer interrupt at the timing when the power-on sequence in step S65 described above is completed.

The power supplies of all of the in-sensor PD 21, the in-sensor PD 22, the in-AP PD 31, and the in-AP PD 32 are turned on. The subsequent processing until an image data transfer is started again (until the state returns to the Active state) is illustrated as steps S68 to S72.

In step S68, the CPU 205 writes activation of the TxIF circuit 23 in the register 201 in order to start retraining.

In step S69, link training for establishing communication between the TxIF circuit 23 and the RxIF circuit 33 is performed.

In step S70, the TxIF circuit 23 (in-sensor PD 21) notifies the CPU 205 of a training completion interrupt indicating that the link training in step S67 described above is completed.

In step S71, the RxIF circuit 33 (in-AP PD 32) notifies the CPU 305 of a training completion interrupt indicating that the link training in step S69 described above is completed.

In step S72, the CPU 205 writes transfer (transfer start) of the image data in the register 201. The transfer of the image data is started. The TxIF circuit 23 and the RxIF circuit 33 recover to the Active state.

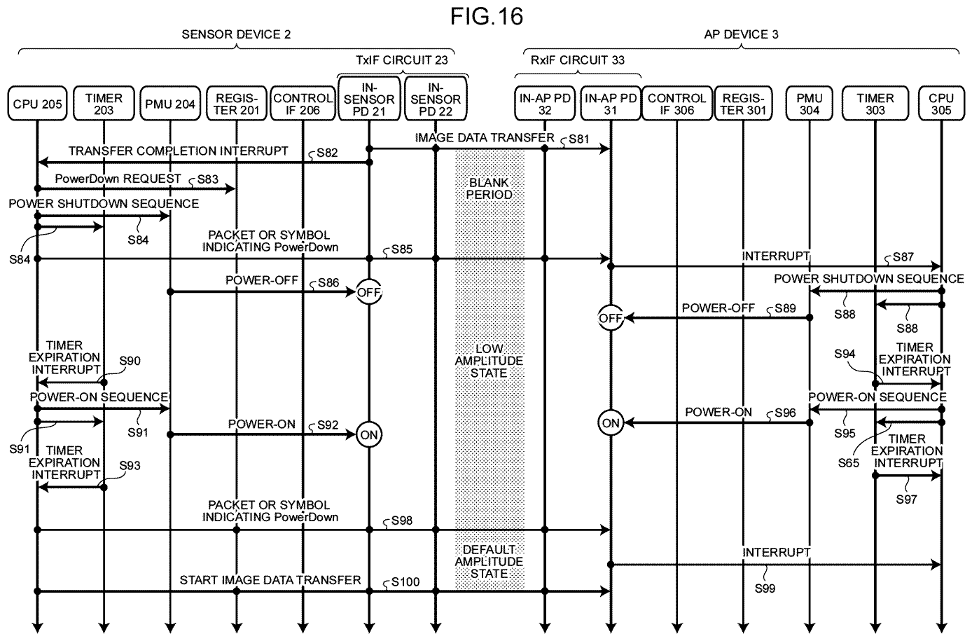

FIG. 16 illustrates an exemplary processing flow in a case where the TxIF circuit 23 of the sensor device 2 and the RxIF circuit 33 of the AP device 3 enter the HalfInactive state during a blank period. The HalfInactive state in this example includes a transition to the low amplitude state and the default amplitude state.

The processing until the power shutdown is illustrated as steps S81 to S89.

The processing of steps S81 to S83 is the same as the processing of steps S51 to S53 of FIG. 15 described above.

In this example, it is based on a premise that the Sleep time set in the register 201 and the register 301 is longer than the recovery time from the power shutdown (step S9 described above in FIG. 13: Yes, step S29 in FIG. 14: Yes).

In step S84, the CPU 205 controls the PMU 204 and activates the timer 203 for PowerDown (power shutdown sequence).

In step S85, under the control of the CPU 205, the TxIF circuit 23 transmits a packet or a symbol indicating PowerDown to the RxIF circuit 33.

In step S86, the PMU 204 cuts off the power supply of the in-sensor PD 21.

In step S87, the RxIF circuit 33 (in-AP PD 31) notifies the CPU 305 of an interrupt indicating that the packet or the symbol in step S85 has been received.

In step S88, the CPU 305 controls the PMU 304 and activates the timer 303 for PowerDown (power shutdown sequence).

In step S89, the PMU 304 cuts off the power supply of the in-AP PD 31.

The TxIF circuit 23 and the RxIF circuit 33 enter the HalfInactive state, more specifically, a low amplitude Idle state. The TxIF circuit 23 transmits the Idle data having a low amplitude to the RxIF circuit 33. The RxIF circuit 33 receives an Idle signal having the low amplitude from the TxIF circuit 23. The communication between the TxIF circuit 23 and the RxIF circuit 33 is kept established (link is maintained).

In step S90, the timer 203 notifies the CPU 205 of a timer expiration interrupt.

In step S91, the CPU 205 controls the PMU 204 and activates the timer 203 (power-on sequence).

In step S92, the PMU 204 turns on the power supply of the in-sensor PD 21.

In step S93, the timer 203 notifies the CPU 205 of completion of a timer interrupt at the timing when the power-on sequence in step S91 described above is completed.

In step S94, the timer 303 notifies the CPU 305 of the timer completion interrupt.

In step S95, the CPU 305 controls the PMU 304 and activates the timer 303 (power-on sequence).

In step S96, the PMU 304 turns on the power supply of the in-AP PD 31.

In step S97, the timer 303 notifies the CPU 305 of completion of the timer interrupt at the timing when the power-on sequence in step S95 described above is completed.

In step S98, under the control of the CPU 205, the TxIF circuit 23 transmits a packet or a symbol indicating PowerUp to the RxIF circuit 33.

In step S99, the RxIF circuit 33 (in-AP PD 31) notifies the CPU 305 of an interrupt indicating that the packet or the symbol in step S98 has been received.

The TxIF circuit 23 and the RxIF circuit 33 enter the default amplitude state. The TxIF circuit 23 transmits the Idle data having the default amplitude to the RxIF circuit 33. The RxIF circuit 33 receives an Idle signal having the default amplitude from the TxIF circuit 23.

In step S100, the CPU 205 writes transfer (transfer start) of the image data in the register 201. The transfer of the image data is started. The TxIF circuit 23 and the RxIF circuit 33 recover to the Active state. To recover to the Active state, the link training as illustrated in FIG. 15 described above is unnecessary.

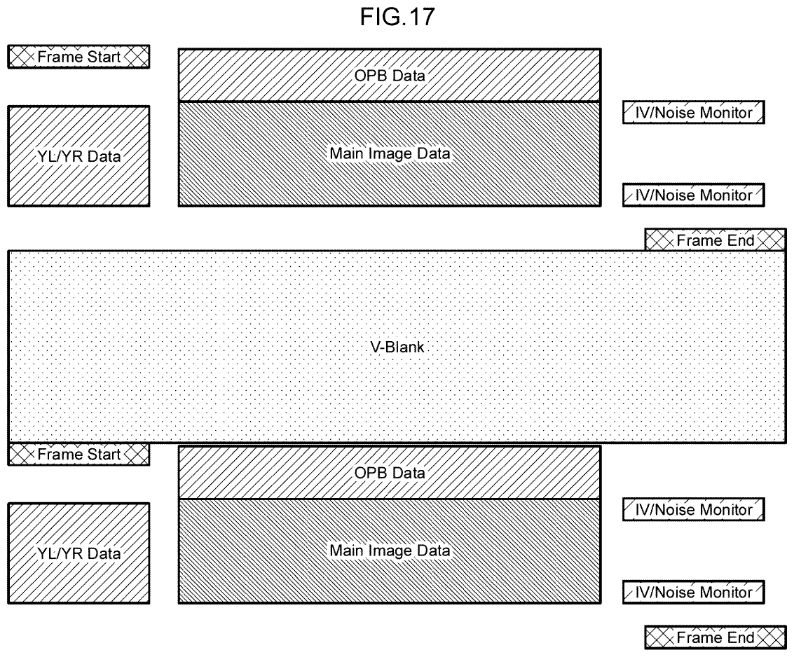

FIG. 17 is a diagram illustrating an exemplary structure of data transferred from the sensor device 2 to the AP device 3. Various types of data as illustrated in the example are transferred as packets.

Frame Start is data indicating the start of a frame as the name indicates. OPB Data is (optically Black) data obtained from a pixel region in which light is shielded from the outside. YL/YR Data is data used as an image plane phase difference, and is, for example, luminance data. Main Image Data is image data obtained from an effective pixel region. IV/Noise Monitor is data indicating information such as the current, the voltage, or noise of the sensor device 2. Frame End is data indicating the end of the frame as the name indicates. The data from Frame Start to Frame End described above constitutes data of one frame.

There is a blank period (V-Blank) between frames. The longer the blank period is, the longer the Sleep time set to the register 201 and the register 301 as described above can be. The power-on and power-off of each of the in-sensor PD 21, the in-sensor PD 22, the in-AP PD 31, and the in-AP PD 32 are individually controlled depending on the Sleep time or the like, and the trade-off between the reduction in power consumption and the recovery time from a power shutdown is improved.

### 2. Modifications

The technology disclosed is not limited to the above embodiments. For example, in the above embodiment, the case where the sensor device 2 is an imaging device has been described. However, the sensor device 2 is not limited to an imaging device. Any sensor device to which the disclosed technology can be applied may be the sensor device 2. The sensor system 1 is also not limited to an imaging system. Any data acquired by the sensor device 2 may be transmitted from the TxIF circuit 23 of the sensor device 2 to the RxIF circuit 33 of the AP device 3. The term “image data” described in the embodiment may be rephrased as “data acquired by the sensor device 2”, “data indicating a sensing result of the sensor device 2”, or simply “data” or the like as long as there is no contradiction.

In the above embodiment, in the sensor device 2, the case where the TxIF circuit 23 is provided across the two in-sensor PDs of the in-sensor PD 21 and the in-sensor PD 22 has been described as an example. However, the TxIF circuit 23 may be provided across three or four or more in-sensor PDs. The sensor device 2 may include such a plurality of in-sensor PDs. Similarly, in the above embodiment, in the AP device 3, the case where the RxIF circuit 33 is provided across the two in-sensor PDs of the in-AP PD 31 and the in-AP PD 32 has been described as an example. However, the RxIF circuit 33 may be provided over three or four or more in-AP PDs. The AP device 3 may include such a plurality of in-AP PDs.

In the above embodiment, the case where the image processor 202 of the sensor device 2 is included in the in-sensor PD 20 has been described as an example. However, the image processor 202 may be included in a power domain which is always powered on and is different from the in-sensor PD 20. Similarly, in the above embodiment, the case where the image processor 302 of the AP device 3 is included in the in-AP PD 30 has been described as an example. However, the image processor 302 may be included in a power domain which is always powered on and is different from the in-AP PD 30.

The technology used for communication between the sensor device 2 and the AP device 3 is not particularly limited. For example, a full-duplex communication technology such as PCIe or USB may be used, or technology such as DP2.1 or mipi in which a signal line of a high-speed serial interface and a signal line of a control interface are separated may be used.

### 3. Summary

The technology described above is specified as follows, for example. One of the disclosed technologies is a sensor system 1. As described with reference to FIGS. 1 to 16 and others, the sensor system 1 includes the sensor device 2 (for example, an imaging device) and the AP device 3 that uses the sensor device 2. The sensor device 2 includes: the in-sensor PD 21 (first in-sensor PD) and the in-sensor PD 22 (second in-sensor PD) of which power-on and power-off can be individually controlled; and a TxIF circuit 23 that is provided across the in-sensor PD 21 and the in-sensor PD 22 and transmits data (for example, image data). The AP device 3 includes: the in-AP PD 31 (first in-AP PD) and the in-AP PD 32 (second in-AP PD) of which power-on and power-off can be individually controlled; and an RxIF circuit 33 which is provided across the in-AP PD 31 (first in-AP PD) and the in-AP PD 32 (second in-AP PD) and receives the data. The in-sensor PD 21 and the in-AP PD 31 provide a layer higher than the physical layer. The in-sensor PD 22 and the in-AP PD 32 provide the physical layer. Note that the sensor device 2 is also one of the disclosed technologies, and the AP device 3 is also one of the disclosed technologies.

According to the sensor system 1 (sensor device 2 and AP device 3) described above, in the sensor device 2, it is possible to individually control power-on and power-off of each of the in-sensor PD 21 and the in-sensor PD 22. In the AP device 3, power-on and power-off of the in-AP PD 31 and the in-AP PD 32 can be individually controlled. Therefore, it is possible to more finely control the reduction of the power consumption and the recovery time from a power shutdown than in a case where the power supply of the in-sensor PD 21, the in-sensor PD 22, the in-AP PD 31, and the in-AP PD 32 can only be turned on or off all together. As a result, it is possible to improve the trade-off between the reduction in power consumption due to a power shutdown and the recovery time from the power shutdown.

As described with reference to FIGS. 1 and 2 and others, the TxIF circuit 23 may include the LINK circuit 212 included in the in-sensor PD 21 and the PHY circuit 220 included in the in-sensor PD 22, and the RxIF circuit 33 may include the LINK circuit 312 included in the in-AP PD 31 and the PHY circuit 320 included in the in-AP PD 32. For example, by combining power-on and power-off of the in-sensor PD 21 and the in-sensor PD 22 including the TxIF circuit 23 as described above and the in-AP PD 31 and the in-AP PD 32 including the RxIF circuit 33, it is possible to control the reduction in power consumption and the recovery time from a power shutdown (the length of time until recovering to the Active state).

As described with reference to FIGS. 3 and 4 and others, the state of the TxIF circuit 23 may include the Active state in which the power supplies of both the in-sensor PD 21 and the in-sensor PD 22 are turned on, the HalfInactive state in which the power supply of the in-sensor PD 21 is turned off, whereas the power supply of the in-sensor PD 22 is turned on, and the Inactive state in which the power supplies of both the in-sensor PD 21 and the in-sensor PD 22 are turned off, and the state of the RxIF circuit 33 may include the Active state in which the power supplies of both the in-AP PD 31 and the in-AP PD 32 are turned on, the HalfInactive state in which the power supply of the in-AP PD 31 is turned off, whereas the power supply of the in-AP PD 32 is turned on, and the Inactive state in which the power supplies of both the in-AP PD 31 and the in-AP PD 32 are turned off. The TxIF circuit 23 and the RxIF circuit 33 may perform state transition in such a manner as to be in the same state. For example, by using such state transitions of the TxIF circuit 23 and the RxIF circuit 33, it is possible to control reduction of power consumption and the recovery time from a power shutdown.

As described with reference to FIGS. 3 and 4 and others, the TxIF circuit 23 in the HalfInactive state may transmit the Idle data, and the RxIF circuit 33 in the HalfInactive state may receive the Idle data from the TxIF circuit 23. As a result, communication between the TxIF circuit 23 and the RxIF circuit 33 can be kept established, and the recovery time can be shortened accordingly.

As described with reference to FIGS. 3 to 8 and others, the HalfInactive state of the TxIF circuit 23 includes: the default amplitude state of transmitting Idle data having the default amplitude; and the low amplitude state of transmitting Idle data having the low amplitude, and the HalfInactive state of the RxIF circuit 33 includes: the default amplitude state of receiving the Idle data having the default amplitude from the TxIF circuit 23; and the low amplitude state of receiving the Idle data having the low amplitude from the TxIF circuit 23. In addition, transmission of Idle data by the TxIF circuit 23 may include intermittent transmission, and reception of Idle data by the RxIF circuit 33 may include intermittent reception. This increases the possibility of further reducing the power consumption.

As described with reference to FIGS. 3, 4, 13 to 15, and others, the transition from the Inactive state to the Active state may include link training for establishing communication between the TxIF circuit 23 and the RxIF circuit 33, and the transition from the HalfInactive state to the Active state may not include link training. As a result, the recovery time from the HalfInactive state to the Active state can be made shorter than the recovery time from the Inactive state to the Active state.

As described with reference to FIGS. 13 and 14 and others, the states of the TxIF circuit 23 and the RxIF circuit 33 may transition to the Inactive state in a case where the set Sleep time is longer than the set recovery time from a power shutdown by longer than or equal to the first threshold time (processing if Yes in step S3 and processing if Yes in step S23) and transition to the HalfInactive state in a case where the set Sleep time is longer than the set recovery time from a power shutdown by longer than or equal to the second threshold time which is shorter than the first threshold time (processing if Yes in step S9 and processing if Yes in step S29). For example, in this manner, the Inactive state and the HalfInactive state can be selectively used.

Note that the effects described herein are merely examples, and it is not limited to the disclosed content. There may be other effects.

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

Note that the present technology can also have the following configurations.
(1) A sensor system comprising:
   a sensor device; and
   an application processor (AP) device that uses the sensor device,
   wherein the sensor device includes:
   a first in-sensor power domain (PD) and a second in-sensor PD of which power-on and power-off can be individually controlled; and
   a TxIF circuit that is provided across the first in-sensor PD and the second in-sensor PD and transmits data,
   the AP device includes:
   a first in-AP PD and a second in-AP PD of which power-on and power-off can be individually controlled; and
   an RxIF circuit that is provided across the first in-AP PD and the second in-AP PD and receives the data,
   the first in-sensor PD and the first in-AP PD provide a layer higher than a physical layer, and
   the second in-sensor PD and the second in-AP PD provide the physical layer.
(2) The sensor system according to (1),
   wherein the TxIF circuit includes:
   a LINK circuit included in the first in-sensor PD; and
   a PHY circuit included in the second in-sensor PD, and
   the RxIF circuit includes:
   a LINK circuit included in the first in-AP PD; and
   a PHY circuit included in the second in-AP PD.
(3) The sensor system according to (1) or (2),
   wherein a state of the TxIF circuit includes:
   an Active state in which power supplies of both the first in-sensor PD and the second in-sensor PD are turned on;
   a HalfInactive state in which the power supply of the first in-sensor PD is turned off, whereas the power supply of the second in-sensor PD is turned on; and
   an Inactive state in which the power supplies of both the first in-sensor PD and the second in-sensor PD are turned off,
   a state of the RxIF circuit includes:
   an Active state in which power supplies of both the first in-AP PD and the second in-AP PD are turned on;
   a HalfInactive state in which the power supply of the first in-AP PD is turned off, whereas the power supply of the second in-AP PD is turned on; and
   an Inactive state in which the power supplies of both the first in-AP PD and the second in-AP PD are turned off, and
   the TxIF circuit and the RxIF circuit perform state transition in such a manner as to be in a same state.
(4) The sensor system according to (3),
   wherein the TxIF circuit in the HalfInactive state transmits Idle data, and
   the RxIF circuit in the HalfInactive state receives the Idle data from the TxIF circuit.
(5) The sensor system according to (4),
   wherein the HalfInactive state of the TxIF circuit includes:
   a default amplitude state of transmitting Idle data having a default amplitude; and
   a low amplitude state of transmitting Idle data having a low amplitude, and
   the HalfInactive state of the RxIF circuit includes:
   a default amplitude state of receiving the Idle data having the default amplitude from the TxIF circuit; and
   a low amplitude state of receiving the Idle data having the low amplitude from the TxIF circuit.
(6) The sensor system according to (4) or (5),
   wherein the transmission of the Idle data by the TxIF circuit includes intermittent transmission, and
   the reception of the Idle data by the RxIF circuit includes intermittent reception.
(7) The sensor system according to any one of (3) to (6),
   wherein transition from the Inactive state to the Active state includes link training for establishing communication between the TxIF circuit and the RxIF circuit, and
   transition from the HalfInactive state to the Active state does not include the link training.
(8) The sensor system according to any one of (3) to (7),
   wherein states of the TxIF circuit and the RxIF circuit:
   transition to the Inactive state in a case where set Sleep time is longer than set recovery time from a power shutdown by more than or equal to a first threshold time, and
   transition to the HalfInactive state in a case where the set Sleep time is longer than the set recovery time from a power shutdown by more than or equal to a second threshold time which is shorter than the first threshold time.
(9) The sensor system according to any one of (1) to (8),
   wherein the sensor device is an imaging device, and
   the data includes image data.
(10) A sensor device comprising:
   a first in-sensor power domain (PD) and a second in-sensor PD of which power-on and power-off can be individually controlled; and
   a TxIF circuit that is provided across the first in-sensor PD and the second in-sensor PD and transmits data,
   wherein the first in-sensor PD provides a layer higher than a physical layer, and
   the second in-sensor PD provides the physical layer.
(11) The sensor device according to (10),
   wherein the TxIF circuit includes:
   a LINK circuit included in the first in-sensor PD; and
   a PHY circuit included in the second in-sensor PD.
(12) The sensor device according to (10) or (11),
   wherein a state of the TxIF circuit includes:
   an Active state in which power supplies of both the first in-sensor PD and the second in-sensor PD are turned on;
   a HalfInactive state in which the power supply of the first in-sensor PD is turned off, whereas the power supply of the second in-sensor PD is turned on; and
   an Inactive state in which the power supplies of both the first in-sensor PD and the second in-sensor PD are turned off.
(13) An application processor (AP) device that uses a sensor device, the AP device comprising:
   a first in-AP power domain (PD) and a second in-AP PD of which power-on and power-off can be individually controlled; and
   an RxIF circuit that receives data from the sensor device, the RxIF circuit provided across the first in-AP PD and the second in-AP PD,
   wherein the first in-AP PD provides a layer higher than a physical layer, and
   the second in-AP PD provides the physical layer.
(14) The AP device according to (13),
   wherein the RxIF circuit includes:
   a LINK circuit included in the first in-AP PD; and
   a PHY circuit included in the second in-AP PD.
(15) The AP device according to (13) or (14),
   wherein the RxIF circuit includes:
   an Active state in which power supplies of both the first in-AP PD and the second in-AP PD are turned on;
   a HalfInactive state in which the power supply of the first in-AP PD is turned off, whereas the power supply of the second in-AP PD is turned on; and
   an Inactive state in which the power supplies of both the first in-AP PD and the second in-AP PD are turned off.

### Reference Signs List

1 SENSOR SYSTEM
2 SENSOR DEVICE
20 IN-SENSOR PD
201 REGISTER
202 IMAGE PROCESSOR
203 TIMER
204 PMU
204a POWER SEQUENCER CIRCUIT
205 CPU
206 CONTROL IF
21 IN-SENSOR PD
211 DATA CONVERSION CIRCUIT
211a BUFFER
212 LINK CIRCUIT
212a PACKET GENERATION CIRCUIT
212b PACKET ARBITRATION CIRCUIT
212c LANE DISTRIBUTION CIRCUIT
212d CONTROL SYMBOL INSERTING CIRCUIT
213 ISO CIRCUIT
22 IN-SENSOR PD
221 PHYDig CIRCUIT
221a LINK TEST CIRCUIT
221b SCRAMBLER CIRCUIT
221c CODING CIRCUIT
221d PHYAnalog CONTROL CIRCUIT
222 PHYAnalog CIRCUIT
23 TxIF CIRCUIT
3 AP DEVICE
30 IN-AP PD
301 REGISTER
302 IMAGE PROCESSOR
303 TIMER
304 PMU
305 CPU
306 CONTROL IF
31 IN-AP PD
311 DATA CONVERSION CIRCUIT
312 LINK CIRCUIT
313 ISO CIRCUIT
32 IN-AP PD
320 PHY CIRCUIT
321 PHYDig CIRCUIT
322 PHYAnalog CIRCUIT
33 RxIF CIRCUIT

1. A sensor system comprising:
a sensor device; and
an application processor (AP) device that uses the sensor device,
wherein the sensor device includes:
a first in-sensor power domain (PD) and a second in-sensor PD of which power-on and power-off can be individually controlled; and
a TxIF circuit that is provided across the first in-sensor PD and the second in-sensor PD and transmits data,
the AP device includes:
a first in-AP PD and a second in-AP PD of which power-on and power-off can be individually controlled; and
an RxIF circuit that is provided across the first in-AP PD and the second in-AP PD and receives the data,
the first in-sensor PD and the first in-AP PD provide a layer higher than a physical layer, and
the second in-sensor PD and the second in-AP PD provide the physical layer.

2. The sensor system according to claim 1,
wherein the TxIF circuit includes:
a LINK circuit included in the first in-sensor PD; and
a PHY circuit included in the second in-sensor PD, and
the RxIF circuit includes:
a LINK circuit included in the first in-AP PD; and
a PHY circuit included in the second in-AP PD.

3. The sensor system according to claim 1,
wherein a state of the TxIF circuit includes:
an Active state in which power supplies of both the first in-sensor PD and the second in-sensor PD are turned on;
a HalfInactive state in which the power supply of the first in-sensor PD is turned off, whereas the power supply of the second in-sensor PD is turned on; and
an Inactive state in which the power supplies of both the first in-sensor PD and the second in-sensor PD are turned off,
a state of the RxIF circuit includes:
an Active state in which power supplies of both the first in-AP PD and the second in-AP PD are turned on;
a HalfInactive state in which the power supply of the first in-AP PD is turned off, whereas the power supply of the second in-AP PD is turned on; and
an Inactive state in which the power supplies of both the first in-AP PD and the second in-AP PD are turned off, and
the TxIF circuit and the RxIF circuit perform state transition in such a manner as to be in a same state.

4. The sensor system according to claim 3,
wherein the TxIF circuit in the HalfInactive state transmits Idle data, and
the RxIF circuit in the HalfInactive state receives the Idle data from the TxIF circuit.

5. The sensor system according to claim 4,
wherein the HalfInactive state of the TxIF circuit. includes:
a default amplitude state of transmitting Idle data having a default amplitude; and
a low amplitude state of transmitting Idle data having a low amplitude, and
the HalfInactive state of the RxIF circuit includes:
a default amplitude state of receiving the Idle data having the default amplitude from the TxIF circuit; and
a low amplitude state of receiving the Idle data having the low amplitude from the TxIF circuit.

6. The sensor system according to claim 4,
wherein the transmission of the Idle data by the TxIF circuit includes intermittent transmission, and
the reception of the Idle data by the RxIF circuit includes intermittent reception.

7. The sensor system according to claim 3,
wherein transition from the Inactive state to the Active state includes link training for establishing communication between the TxIF circuit and the RxIF circuit, and
transition from the HalfInactive state to the Active state does not include the link training.

8. The sensor system according to claim 3,
wherein states of the TxIF circuit and the RxIF circuit:
transition to the Inactive state in a case where set. Sleep time is longer than set recovery time from a power shutdown by more than or equal to a first threshold time, and
transition to the HalfInactive state in a case where the set Sleep time is longer than the set recovery time from a power shutdown by more than or equal to a second threshold time which is shorter than the first threshold time.

9. The sensor system according to claim 1,
wherein the sensor device is an imaging device, and
the data includes image data.

10. A sensor device comprising:
a first in-sensor power domain (PD) and a second in-sensor PD of which power-on and power-off can be individually controlled; and
a TxIF circuit that is provided across the first in-sensor PD and the second in-sensor PD and transmits data,
wherein the first in-sensor PD provides a layer higher than a physical layer, and
the second in-sensor PD provides the physical layer.

11. The sensor device according to claim 10,
wherein the TxIF circuit includes:
a LINK circuit included in the first in-sensor PD; and
a PHY circuit included in the second in-sensor PD.

12. The sensor device according to claim 10,
wherein a state of the TxIF circuit includes:
an Active state in which power supplies of both the first in-sensor PD and the second in-sensor PD are turned on;
a HalfInactive state in which the power supply of the first in-sensor PD is turned off, whereas the power supply of the second in-sensor PD is turned on; and
an Inactive state in which the power supplies of both the first in-sensor PD and the second in-sensor PD are turned off.

13. An application processor (AP) device that uses a sensor device, the AP device comprising:
a first in-AP power domain (PD) and a second in-AP PD of which power-on and power-off can be individually controlled; and
an RxIF circuit that receives data from the sensor device, the RxIF circuit provided across the first in-AP PD and the second in-AP PD,
wherein the first in-AP PD provides a layer higher than a physical layer, and
the second in-AP PD provides the physical layer.

14. The AP device according to claim 13,
wherein the RxIF circuit includes:
a LINK circuit included in the first in-AP PD; and
a PHY circuit included in the second in-AP PD.

15. The AP device according to claim 13,
wherein the RxIF circuit includes:
an Active state in which power supplies of both the first in-AP PD and the second in-AP PD are turned on;
a HalfInactive state in which the power supply of the first in-AP PD is turned off, whereas the power supply of the second in-AP PD is turned on; and
an Inactive state in which the power supplies of both the first in-AP PD and the second in-AP PD are turned off.
